(19) United States
(12) Patent Application Publication
(10) Pub. No.: US 2023/0407112 A1
(43) Pub. Date: Dec. 21, 2023

(54) CONDUCTIVE PASTE COMPOSITION, CONDUCTIVE FILM, AND ELECTRICALLY RESISTANT SENSOR

(71) Applicants: Lion Specialty Chemicals Co., Ltd., Tokyo (JP); University of Hyogo, Hyogo (JP)

(72) Inventors: Kasumi MUKAIDA, Tokyo (JP); Hiromu SATO, Tokyo (JP); Katsuyoshi OHARA, Tokyo (JP); Akinori KANETANI, Tokyo (JP); Kazusuke MAENAKA, Kobe-shi (JP); Mai KONDO, Kobe-shi (JP); Tokuji YOKOMATSU, Kobe-shi (JP)

(73) Assignees: Lion Specialty Chemicals Co., Ltd., Tokyo (JP); University of Hyogo, Hyogo (JP)

(21) Appl. No.: 18/248,837

(22) PCT Filed: Oct. 15, 2021
(86) PCT No.: PCT/JP2021/038321

§ 371 Date: Apr. 12, 2023

(30) Foreign Application Priority Data
Oct. 15, 2020 (JP) 2020-174233

(51) Int. Cl. C09D 5/24; C09D 7/61; C09D 183/04; H01C 10/10; G01B 7/16

(52) U.S. Cl. CPC C09D 5/24; C09D 7/61; C08K 3/04; H01C 10/10; G01B 7/18; C09D 183/04

(57) ABSTRACT

A conductive paste composition includes: carbon black having a porous structure and having a DBP oil absorption amount of greater than 240 mL/100 g and a specific surface area of greater than 350 m²/g; and a liquid silicone rubber base composition, in which in a case where the conductive paste composition is dried and cured at 180° C. for two hours to form a conductive film, a content of the carbon black in the conductive film is 4% by mass or greater and 24% by mass or less, and a surface resistance of the conductive film is 1 kΩ or greater and 9 kΩ or less.

### TECHNICAL FIELD

The present invention relates to a conductive paste composition, a conductive film, and an electrically resistant sensor.

Priority is claimed on Japanese Patent Application No. 2020-174233, filed in Japan on Oct. 15, 2020, the content of which is incorporated herein by reference.

### BACKGROUND ART

Currently, introduction of various sensors from industrial applications to daily applications is being considered.

An electrically resistant sensor using a metal paste material such as silver is excellent in sensing sensitivity or sensing stability. On the other hand, an electrically resistant sensor using a metal material is susceptible to an external environment in addition to high cost. Therefore, the electrically resistant sensor using a metal material has a problem that stable sensing cannot be performed for a long period of time. For example, silver paste is unstable for a long time because it is poor in oxidation or migration.

Therefore, an electrically resistant sensor using a carbon material has been developed.

An electrically resistant sensor using a carbon material is formed of a conductive composition containing a carbon material.

For example, as the conductive composition containing a carbon material, a conductive liquid silicone composition for a coating material, which contains (A) 100 parts by mass of a condensation reaction-type polyorganosiloxane with a specific degree of polymerization, (B) 0.5 to 30 parts by mass of a specific silicone oil, (C) 5 to 100 parts by mass of conductive carbon black, (D) a required amount of a curing agent, and (E) 10 to 2,000 parts by mass of a solvent with respect to 100 parts by mass of the component of (A) polyorganosiloxane, is known (for example, see Patent Document 1).

For example, as the conductive composition containing a carbon material, a carbon nanotube composite material in which carbon nanotubes are dispersed in a matrix is known. In the carbon nanotube composite material, a specific peak is observed by Raman spectroscopic analysis at a wavelength of 633 nm, and a ratio R/R0 of an electrical resistance R after 100 repetitions of stress at 10% elongation with respect to a resistance R0 before loading is 3 or less (for example, see Patent Document 2).

As the conductive composition containing a carbon material, for example, a crosslinked elastomer body for a sensor, which is made of a conductive composition containing a conductive filler and an insulating elastomer as essential components is known. The crosslinked elastomer body for a sensor has a critical volume fraction ((pc) of the conductive filler of 35 vol % to 55 vol %. In addition, in a specific region of the crosslinked elastomer body for a sensor, a resistance in a state where compressive or bending strain is applied increases in accordance with an amount of strain compared to when no strain is applied (for example, see Patent Document 3).

### CITATION LIST

### Patent Documents

### [Patent Document 1]

Japanese Patent No. 5191977

### [Patent Document 2]

Japanese Patent No. 5757542

### [Patent Document 3]

Japanese Patent No. 5166714

### SUMMARY OF INVENTION

### Technical Problem

By using the conductive paste containing a carbon material in place of the metal paste material, a sensor with low cost, flexibility, and excellent weather resistance can be expected to be manufactured. An application target of the conductive liquid silicone composition for a coating material, which contains carbon black, disclosed in Patent Document 1 is a circuit. However, Patent Document 1 does not disclose a use of the conductive liquid silicone composition for a coating material as a sensor. Patent Document 1 has not been verified or optimized for a case where the conductive liquid silicone composition for a coating material is used as a sensor. In Patent Document 2, the user of a sensor of conductive ink using carbon nanotubes is examined, and sensing stability with respect to strain is clarified. However, Patent Document 2 has not been verified for external temperature factors that affect sensing stability. The crosslinked elastomer body for a sensor disclosed in Patent Document 3 contains a large amount of carbon materials and is not suitable for flexible sensor applications. Patent Document 3 has not been verified for sensing stability against strain or temperature.

Accordingly, an object of the present invention is to provide a conductive paste composition capable of realizing an electrically resistant sensor having excellent sensing stability. Another object of the present invention is to provide a conductive film formed of the conductive paste composition. Still another object of the present invention is to provide an electrically resistant sensor including a sensing unit made of the conductive film.

### Solution to Problem

The present inventors have found the following results of extensive studies. A conductive film was manufactured such that surface resistance, which is highly applicable as a sensor, is 1 kΩ or greater and 9 kΩ or less. In order to obtain the conductive film, a conductive paste is prepared by blending porous carbon black into a liquid silicone rubber base composition generally having excellent biocompatibility. The conductive film has a small temperature dependency of the surface resistance at a temperature of 10° C. or higher and 50° C. or lower, and the surface resistance is stable even against strain of 0.5% to 5.0%, thereby obtaining excellent sensing stability. In addition, porous carbon black having a DBP oil absorption amount and a specific surface area within specific ranges has excellent sensing stability compared to other carbon blacks and carbon nanotubes, and is at a practical level.

That is, the present inventors have found the following results and completed the present invention. The conductive paste composition containing the DBP oil absorption amount, porous carbon black having a specific surface area within specific ranges, and a silicone rubber base composition can exhibit sensing stability.

That is, the present invention has the following aspects.

[1] A conductive paste composition includes: carbon black having a porous structure and having a DBP oil absorption amount of greater than 240 mL/100 g and a specific surface area of greater than 350 m²/g; and a liquid silicone rubber base composition,
in which in a case where the conductive paste composition is dried and cured at 180° C. for two hours to form a conductive film, a content of the carbon black in the conductive film is 4% by mass or greater and 24% by mass or less, and a surface resistance of the conductive film is 1 kΩ or greater and 9 kΩ or less.

[2] The conductive paste composition according to [1], in which when deformation is repeatedly performed at a predetermined strain value within a range of a strain of 0.5% to 5.0%, the conductive film obtained from the conductive paste composition simultaneously satisfies the following (A) and (B) as indices of sensing stability against the strain:
(A) Stability under 0% strain (change in surface resistance of the conductive film in a state where the strain is 0% before and after the repeated deformation) is less than 2%, and
(B) Stability under (0.5% to 5.0%) strain (change in surface resistance of the conductive film in a state where the strain is 0.5% to 5.0% immediately after the deformation and after the repeated deformation) is less than 2%.

[3] The conductive paste composition according to [1] or [2], in which when a deformation is repeatedly performed at a predetermined strain value within a range of a strain of 0.5% to 5.0%, the conductive film obtained from the conductive paste composition satisfies the following (C) as an index of sensing stability against the strain:
(C) Sensing sensitivity when the strain is applied is good in terms of reproducibility and presence/absence of noise.

[4] The conductive paste composition according to any one of [1] to [3], in which the conductive film obtained from the conductive paste composition has a resistance change rate of 5% or less, which is defined as a ratio of a number of increase in surface resistance after temperature change (a humidity of 60%, a temperature of higher than 10° C. and 50° C. or lower) to a number of increase in surface resistance before the temperature change (a humidity of 60%, a temperature of 10° C.).

[5] The conductive paste composition according to any one of [1] to [4], in which the DBP oil absorption amount of the carbon black is preferably 240 mL/100 g or greater and 520 mL/100 g or less, more preferably 300 mL/100 g or greater and 500 mL/100 g or less, and still more preferably 400 mL/100 g or greater and 480 mL/100 g or less.

[6] The conductive paste composition according to any one of [1] to [5], in which the specific surface area of the carbon black is preferably greater than 350 m²/g and 1,700 m²/g or less, more preferably 700 m²/g or greater and 1,600 m²/g or less, and still more preferably 1,200 m²/g or greater and 1,500 m²/g or less.

[7] The conductive paste composition according to any one of [1] to [6], in which the content of the carbon black is preferably 4% by mass or greater and 24% by mass or less, more preferably 7% by mass or greater and 13% by mass or less, and still more preferably 8% by mass or greater and 11% by mass or less, with respect to the total mass after removing the solvent from the conductive paste composition.

[8] The conductive paste composition according to any one of [1] to [7], in which the surface resistance is preferably 2 kΩ or greater and 8 kΩ or less, and more preferably 3 kΩ or greater and 7 kΩ or less.

[9] The conductive paste composition according to any one of [1] to [8], in which a tear strength after the curing is 15 kN/m or greater.

[10] A conductive film, which is obtained from the conductive paste composition according to any one of [1] to [9].

[11] An electrically resistant sensor including: a sensing unit including the conductive film according to [10], in which an electrical resistance is changed due to a magnitude of an external stress.

[12] The electrically resistant sensor according to [11] further including: a first electrode wire extending in one direction; a second electrode wire provided to extend in a direction orthogonal to the one direction so as to overlap the first electrode wire; and a resistor including a conductive film configured to connect the first electrode wire and the second electrode wire at a portion where the first electrode wire and the second electrode wire do not overlap each other in which the resistor including the conductive film is the sensing unit.

[13] The electrically resistant sensor according to [12], in which the conductive film has an L shape in plan view.

[14] The electrically resistant sensor according to [12] or [13], in which each of the first electrode wire and the second electrode wire is a plurality of electrode wires provided in parallel, forms a sheet-like sensor, and has one or two or more layers of the sheet-like sensor.

[15] The electrically resistant sensor according to [11], further including: an insulating base material configured to be elastically deformable; and a strain measurement unit formed on the insulating base material and having a U shape in plan view, in which the strain measurement unit is the sensing unit.

[16] The electrically resistant sensor according to [11], further including: an insulating base material configured to be elastically deformable; and a strain measurement unit formed on the insulating base material and having a linear shape in plan view, in which the strain measurement unit is one or more sensing units arranged side by side in the same direction.

### Advantageous Effects of Invention

According to the present invention, it is possible to provide a conductive paste composition capable of realizing an electrically resistant sensor having excellent sensing stability. In addition, according to the present invention, it is possible to provide a conductive film formed of the conductive paste composition. Furthermore, according to the present invention, it is possible to provide an electrically resistant sensor including a sensing unit made of the conductive film.

### BRIEF DESCRIPTION OF DRAWINGS

The electrically resistant sensor using the conductive film formed of the conductive paste composition of the present invention can be applied to a surface pressure distribution sensor, a pulse wave sensor, an acceleration sensor, and the like. The applications of each sensor include bedsore prevention or foot pressure distribution measurement (surface pressure distribution sensor) for bedsore patients, pulse measurement (pulse wave sensor) for adults, infants, fetuses, and pets, motion and behavior detection (acceleration sensor) of humans, and the like.

FIG. 1 is a plan view showing an electrically resistant sensor according to one embodiment of the present invention.

FIG. 2 is a perspective view showing an electrically resistant sensor according to one embodiment of the present invention.

FIG. 3 is a plan view showing an electrically resistant sensor according to one embodiment of the present invention.

FIG. 4 is a plan view showing an electrically resistant sensor according to one embodiment of the present invention.

FIG. 5 is a plan view showing an electrically resistant sensor according to one embodiment of the present invention.

FIG. 6 is a plan view showing a method for manufacturing a surface pressure distribution sensor according to one embodiment of the present invention.

FIG. 7 is a sectional view showing a method for manufacturing a surface pressure distribution sensor according to one embodiment of the present invention.

FIG. 8 is a view showing a control circuit of a surface pressure distribution sensor according to one embodiment of the present invention.

FIG. 9 is a view showing a method for manufacturing an acceleration sensor according to one embodiment of the present invention, in which FIG. 9(A) is a plan view of the acceleration sensor, FIG. 9(B) is a sectional view of the acceleration sensor, and FIG. 9(C) is a perspective view of the acceleration sensor.

FIG. 10 is a view showing a method for manufacturing an acceleration sensor according to one embodiment of the present invention, in which FIG. 10(A) is a plan view of the acceleration sensor, FIG. 10(B) is a sectional view of the acceleration sensor, and FIG. 10(C) is a perspective view of the acceleration sensor.

FIG. 11 is an external view of an acceleration sensor according to one embodiment of the present invention.

FIG. 12 is a view showing a control circuit of an acceleration sensor according to one embodiment of the present invention.

FIG. 13 is a plan view showing a method for manufacturing a pulse wave sensor according to one embodiment of the present invention.

FIG. 14 is a sectional view showing a method for manufacturing a pulse wave sensor according to one embodiment of the present invention.

FIG. 15 is a plan view of a pulse wave sensor according to one embodiment of the present invention.

FIG. 16 is a system block diagram of a pulse wave sensor according to one embodiment of the present invention.

FIG. 17 is a view showing a usage example of a surface pressure distribution sensor according to one embodiment of the present invention.

FIG. 18 is a view showing a usage example of a surface pressure distribution sensor according to one embodiment of the present invention.

FIG. 19 is a view showing a usage example of a surface pressure distribution sensor according to one embodiment of the present invention.

FIG. 20 is a diagram showing sensing waveforms of an acceleration sensor according to one embodiment of the present invention.

FIG. 21 is a diagram showing sensing waveforms of a pulse wave sensor according to one embodiment of the present invention.

### DESCRIPTION OF EMBODIMENTS

Hereinafter, a conductive paste composition, a conductive film, and an electrically resistant sensor according to one embodiment of the present invention will be described.

The present embodiment will be specifically described in order to better understand the gist of the invention, and is not limited to the present invention unless otherwise specified.

[Conductive Paste Composition]

A conductive paste composition of the present embodiment contains carbon black and a liquid silicone rubber base composition.

<Carbon Black>

Examples of carbon black include those commercially available as conductive carbon black, and are not particularly limited. Specifically, examples of carbon black include furnace black, channel black, thermal black, and acetylene black. The furnace black is produced by continuously thermally decomposing a gas or liquid raw material in a reaction furnace. The channel black is obtained by burning a raw material gas, applying a flame thereof to a bottom surface of a channel steel, and quenching and depositing the raw material gas. The thermal black is obtained by periodically repeating combustion and thermal decomposition using gas as a raw material. The acetylene black is obtained by using acetylene gas as a raw material.

The carbon black is a powder composed of secondary particles including a chain of primary particles that are arranged in a cluster shape. n-Dibutyl phthalate (DBP) is absorbed in void portions and the like of the cluster-shaped chain. Therefore, the DBP oil absorption amount is an index value indicating a porosity of the carbon black.

The DBP oil absorption amount of the carbon black is greater than 240 mL/100 g, preferably 240 mL/100 g or greater and 520 mL/100 g or less, more preferably 300 mL/100 g or greater and 500 mL/100 g or less, and still more preferably 400 mL/100 g or greater and 480 mL/100 g or less. When the DBP oil absorption amount of the carbon black is within the above range, excellent conductivity can be easily imparted to the conductive film, and conductivity can be exhibited in the conductive film with a smaller amount of addition. Therefore, the obtained conductive film does not impair flexibility, and as a result, has excellent sensing stability during stretching and contracting. In addition, when the DBP oil absorption amount of the carbon black exceeds the upper limit, dispersibility is significantly impaired. Therefore, it is difficult to produce a uniform conductive paste composition. When the DBP oil absorption amount of the carbon black is less than the lower limit, both conductivity and flexibility cannot be achieved at a predetermined blending amount. The DBP oil absorption amount of the carbon black is measured under conditions in accordance with ASTM D2414.

The specific surface area of the carbon black is greater than 350 m²/g, preferably greater than 350 m²/g and 1,700 m²/g or less, more preferably 700 m²/g or greater and 1,600 m²/g or less, and still more preferably 1,200 m²/g or greater and 1,500 m²/g or less. When the specific surface area of the carbon black is within the above range, a predetermined conductivity can be exhibited with a smaller amount of addition. Therefore, flexibility of the obtained conductive film is not impaired, and as a result, excellent sensing stability is obtained during stretching and contracting. In addition, when the specific surface area of the carbon black exceeds the upper limit, dispersibility is significantly impaired. Therefore, it is difficult to produce a uniform conductive paste composition. When the specific surface area of the carbon black is equal to or less than the lower limit, both conductivity and flexibility cannot be achieved at a predetermined blending amount.

As used herein, the specific surface area refers to a BET specific surface area measured by a BET method using nitrogen adsorption. The specific surface area corresponds to a surface area of the carbon black. The larger the specific surface area, the more the number of carbon black particles per unit area increases with the same amount of addition. As a result, it is possible to achieve conductivity in a small amount of carbon black.

The BET specific surface area is measured by a method in accordance with ASTM D3037. For example, a container containing degassed carbon black is immersed in liquid nitrogen, and an amount of nitrogen adsorbed on a surface of carbon black during equilibrium is measured. A specific surface area (m²/g) is calculated from the amount of nitrogen.

An average primary particle size of carbon black is preferably 20 nm or greater and 55 nm or less, more preferably 25 nm or greater and 40 nm or less, and still more preferably 30 nm or greater and 35 nm or less. When the average primary particle size of carbon black is equal to or greater than the lower limit, dispersibility becomes more better when the carbon black particles kneaded and dispersed in the liquid silicone rubber base composition. When the average primary particle size of carbon black is equal to or less than the upper limit, uneven distribution of large-sized particles of the carbon black in the liquid silicone rubber base composition hardly occurs. Therefore, the surface resistance of the obtained conductive film is stable, and an electrically resistant sensor having good sensing stability can be easily obtained.

The average primary particle size of carbon black is measured by the following method. A sample of the carbon black is added to chloroform and ultrasonically treated for 10 minutes with an ultrasonic dispersion machine to produce a dispersion sample. The produced dispersion sample is sprinkled on a support film reinforced with carbon and fixed. The dispersion sample on the support film is photographed by a transmission electron microscope. The obtained image is magnified 50,000 times to 200,000 times, and particle sizes of 1,000 or more carbon black particles are randomly measured from the magnified image using an Endter's device. An average value of the particle sizes of carbon black is set to an average primary particle size of carbon black.

Examples of commercially available carbon blacks that satisfy the above characteristics include Ketjenblack EC300J, Ketjenblack EC600JD, Lionite EC200L, and Lionite CB, which are manufactured by LION SPECIALTY CHEMICALS CO., Ltd., ENSACO 350G manufactured by Imerys Graphite & Carbon, #3950 manufactured by Mitsubishi Chemical Corporation, Chezacarb manufactured by Unipetrol, and BlackPearls 2000 manufactured by Cabot Corporation.

A content (concentration) of the carbon black in the conductive paste composition of the present embodiment is preferably 4% by mass or greater and 24% by mass or less, more preferably 7% by mass or greater and 13% by mass or less, and still more preferably 8% by mass or greater and 11% by mass or less, with respect to the total mass after removing the solvent from the conductive paste composition. When the content of carbon black is within the above range, it is possible to suppress deterioration of tensile physical properties and the like of the conductive film. When the content of carbon black is less than the lower limit, the obtained conductive film may not exhibit sufficient conductivity. Therefore, sensing may not be performed as a sensor. When the content of carbon black exceeds the upper limit, the obtained conductive film may become hard. Therefore, flexibility of the conductive film is impaired, and sensing stability may not be ensured.

<Liquid Silicone Rubber Base Composition>

The liquid silicone rubber base composition contains a polysiloxane compound which is an organic silicon polymer having a siloxane bond (—Si—O—) as a main chain and having a group such as a methyl group, a phenyl group, a vinyl group, or the like or hydrogen as a side chain. As the polysiloxane compound, a known polysiloxane compound such as a polymer having an alkylsiloxane unit as a main component such as dimethylsiloxane can be used without being particularly limited. The polysiloxane compound may contain a small amount of other structural units or functional groups in addition to the alkylsiloxane unit. Silicone rubber can be roughly divided into an addition reaction type and a condensation reaction type depending on the difference in a curing method. The addition reaction type silicone rubber is a silicone rubber that is cured by addition reaction. Examples of the addition reaction type silicone rubber include silicone rubbers having hydrogen or vinyl groups as side chains. On the other hand, the condensation reaction type silicone rubber is a silicone rubber that is cured by condensation reaction. Examples of condensation reaction type silicone rubber include silicone rubbers having —OH groups at ends thereof. The liquid silicone rubber composition can be obtained by using the silicone rubber as it is commercially available or by additionally blending a solvent.

Examples of the addition reaction type silicone rubber base composition include one-component type RTV rubbers manufactured by Shin-Etsu Chemical Co., Ltd., such as KE-1830, KE-1884, KE-1820, KE-1825, KE-1831, KE-1833, X-32-1947, KE-1056, KE-1151, KE-1842, X-32-1964, KE-1862, X-32-2020, KE-1867, FE-61, FE-57, X-32-1619, and the like. In addition, examples of addition reaction type silicone rubber base composition include two- or three-component RTV rubbers manufactured by Shin-Etsu Chemical Co., Ltd., such as KE-1800T, KE-1031, KE-103, KE-109, KE-1051J, KE-1052, KE-106, KE-1800, KE-1801, KE-1802, KE-1281, KE-1204, KE-521, KE-1861, KE-1222, KE-1241, KE-1300T, KE-1310ST, KE-1314-2, KE-1600, KE-1603, KE-1606, and the like. Examples of curing agent that can be blended into a two-component RTV rubber if necessary, which is manufactured by Shin-Etsu Chemical Co., Ltd., of the addition reaction type include CAT-103, KE-1800B, KE-1800C, CLA-9, CAT-1300, CAT-1310S, CAT-1314S, CAT-1600, CAT-RG, and the like.

Examples of the condensation reaction type silicone rubber base composition include one-component RTV rubber manufactured by Shin-Etsu Chemical Co., Ltd., such as KE-3423, KE-347, KE-3475, KE-3495, KE-4895, KE-4896, KE-3479, KE-348, KE-4897, KE-4898, KE-3424G, KE-3494, KE-3490, KE-40RTV, KE-4890, KE-3497, KE-3498, KE-3493, KE-3466, KE-3467, KE-3491, KE-3492, KE-3417, KE-3418, FE-123, KE-3427, KE-3428, KE-41, KE-42, KE-44, KE-45, KE-441, KE-445, KE-45S, and the like. In addition, examples of the condensation reaction type silicone rubber base composition include two-component RTV rubbers manufactured by Shin-Etsu Chemical Co., Ltd., such as KE-66, KE-200, KE-118, KE-108, KE-119, KE-513, KE-12, KE-14, KE-17, KE-111, KE-113, KE-24, KE-26, KE-1414, KE-1415, KE-1416, KE-1417 and the like. Examples of curing agent that can be blended into the two-component RTV rubber if necessary, which is manufactured by Shin-Etsu Chemical Co., Ltd., of the condensation reaction type include CX200, CAT-118, CAT-108, CAT-RP, CAT-RM, CLC-229, CAT-RT, CAT-24, CX-32-1714, CAT-1417-30, CAT-1417-40, and the like.

As will be described below, the conductive paste composition of the present embodiment preferably has a tear strength of 15 kN/m or greater after curing.

When the carbon black is blended with the silicone rubber base composition and cured, the tear strength tends to be lower than a material obtained by independently curing the silicone rubber base composition. Therefore, in order for the silicone rubber base composition to have a tear strength of 15 kN/m or greater after being blended with carbon black and cured, the silicone rubber base composition itself needs to have a tear strength of at least greater than 15 kN/m. Examples of silicone rubber base composition having the tear strength of greater than 15 kN/m, which can be purchased on the market, include KE-555 manufactured by Shin-Etsu Chemical Co., Ltd., KK-125 manufactured by Togawa Rubber Co., Ltd., RBL-9200 and XIAMETER RBB-2004-40 manufactured by Dow & Toray Co., Ltd. The tear strength was evaluated in accordance with JIS-K-6252-1 (crescent-shaped test piece).

It is known that tear strength can be improved by adjusting an amount of silica blended in the silicone rubber. It is possible to attempt to improve the tear strength of the conductive film obtained after drying the conductive paste composition by blending silica with the silicone rubber base composition before curing while taking into consideration balances of various physical properties.

A silicone rubber, which has a tear strength of greater than 15 kN/m from sources such as the prior art documents “Japanese Patent No. 2739415, Example 1” and “Japanese Unexamined Patent Application, First Publication No. H11-035829, Example 1”, can be produced. For example, from “Japanese Patent No. 2739415, Example 1”, a silicone rubber base composition having a tear strength of greater than 15 Kn/m after curing is obtained by blending 2 parts by mass of methylhydrodienepolysiloxane as organohydrodienepolysiloxane and 0.15 parts by mass of a 2% 2-ethylhexanol solution of chloroplatinic acid as a platinum catalyst into 145 parts by mass of a liquid silicone rubber base composition, which is obtained via 50 parts by mass of dimethylpolysiloxane oil containing vinyl groups at both ends as alkenyl group-containing polysiloxane, 45 parts by mass of silica, 10 parts by mass of hexamethyldisilazane, and 2 parts by mass of water.

The content of the silicone rubber base composition (silicone rubber) after curing in the conductive paste composition is preferably 65% by mass or greater and 96% by mass or less with respect to the total mass after removing the solvent from the conductive paste composition. When the content of the polysiloxane compound is less than the lower limit, a proportion of the silicone rubber in the obtained conductive film is not sufficient, so flexibility is impaired and sensing stability cannot be achieved. When the content of the polysiloxane compound exceeds the upper limit, the content of carbon black in the obtained conductive film is insufficient and conductivity cannot be expressed, so that sensing cannot be performed when used as a sensor.

<Solvent>

The conductive paste composition of the present embodiment contains a solvent derived from the silicone rubber base composition, but the solvent may be added and blended appropriately in order to uniformly disperse carbon black and the liquid silicone rubber base composition.

Examples of the solvent include tetradecane, tridecane, decane, cyclohexanone, ethyl carbitol acetate, and the like.

<Silica>

The conductive paste composition of the present embodiment may be blended with silica to improve the tear strength of the obtained conductive film. Silica has a specific surface area of 50 m²/g or greater. Examples of the silica include fumed silica, precipitated silica, hydrophobized silica, and the like. For example, when silica having a specific surface area of less than 50 m²/g is used, it becomes difficult to obtain a sufficient reinforcing effect.

Examples of commercially available silica satisfying the above characteristics include AEROSIL (registered trademark) 50, 130, 200, 200V, 200CF, 200FAD, 300, 300CF, 380, OX50, TT600, MOX80, MOX170, and COK84, which are manufactured by Nippon Aerosil Co., Ltd., Nipsil (registered trademark) AQ, AQ-S, VN3, LP, L300, N-300A, ER-R, ER, RS-150, ES, NS, NS-T, NS-P, NS-KR, NS-K, NA, KQ, KM, and DS, which are manufactured by Tosoh Silica Corporation, and the like.

A blending amount of silica is preferably 5% by mass or greater and 15% by mass or less with respect to 100 parts by mass of the liquid silicone rubber base composition. When the blending amount of silica is less than the lower limit, the reinforcing effect of the tear strength is insufficient. When the blending amount of silica is equal to or greater than the upper limit, the flexibility of the obtained conductive film is impaired.

The blending amount of silica can be measured using a thermogravimetric analysis device that is set in accordance with JIS K 6226. Heating is performed at 800° C. or higher at which the carbon black burns in an oxygen atmosphere, so that the blending amount of silica can be found out from the weight left as a residue after burning of the silicone rubber and the carbon black.

<Other Components>

The conductive paste composition according to the present embodiment may contain other components, such as a conventional dispersant, a silane coupling agent, and an additive such as an antioxidant, in order to adjust physical properties and the like of the conductive film, to the extent that it does not interfere with the above problems.

A viscosity of the conductive paste composition is preferably 1 Pa s or greater and 50 Pa s or less, more preferably 3 Pa s or greater and 25 Pa s or less, and still more preferably 5 Pa s or greater and 10 Pa s or less. When the viscosity of the conductive paste composition is within the above range, kneading of the carbon black and the liquid silicone rubber base composition is facilitated in the preparation of the conductive paste composition. In addition, coating property during printing is also improved, and a conductive film having a uniform thickness can be easily obtained.

The viscosity of the conductive paste composition was measured using TPE-100H manufactured by Toki Sangyo Co., Ltd., at a room temperature of 25° C., and a shear rate of 20 [1/s] immediately after preparation of the conductive paste. The unit of viscosity is Pa·s.

The viscosity of the conductive paste composition can be adjusted by the blending amount of the solvent.

When the conductive paste composition of the present embodiment is dried and cured at 180° C. for 2 hours to form a conductive film, the content of carbon black in the conductive film is 4% by mass or greater and 24% by mass or less, more preferably 7% by mass or greater and 13% by mass or less, and still more preferably 8% by mass or greater and 11% by mass or less. In a case where the conductive paste composition is dried and cured at 180° C. for 2 hours to form a conductive film, when the content of carbon black in the conductive film is less than the lower limit, a predetermined conductivity may not be exhibited and sufficient sensing stability may not be secured. In addition, when the content of carbon black in the conductive film exceeds the upper limit, the flexibility of the obtained conductive film is impaired, and the sensing stability cannot be thus secured.

The content of carbon black in the conductive film, which is formed by drying and curing the conductive paste composition of the present embodiment at 180° C. for 2 hours, can be measured using a thermogravimetric analysis device that is set in accordance with JIS K 6226. Heating is performed at a certain temperature or higher, so that the blending amount of carbon black blended can be found out from the weight left as a residue after burning of the silicone rubber.

When the conductive paste composition of the present embodiment is dried and cured at 180° C. for 2 hours to form a conductive film, the conductive film has a surface resistance of 1 kΩ or greater and 9 kΩ or less, preferably 2 kΩ or greater and 8 kΩ or less, and more preferably 3 kΩ or greater and 7 kΩ or less. When the conductive paste composition is dried and cured at 180° C. for 2 hours to form a conductive film, optimum sensing stability can be exhibited as a sensing unit of the sensor in the present embodiment as long as the surface resistance of the conductive film is within the above range. When the surface resistance is less than the lower limit, the surface resistance is too high and sensing cannot be performed in the first place. When the upper limit is exceeded, conductivity can be secured, but when the blending amount of carbon black is large, the conductive film becomes hard and sensing stability cannot be exhibited.

The surface resistance is obtained by measuring the surface resistance of the conductive film, which is formed by drying and curing the conductive paste composition of the present embodiment at 180° C. for 2 hours, using a constant current type resistance measurement device.

<Method for Preparing Conductive Paste Composition>

The conductive paste composition can be prepared by blending carbon black into the liquid silicone rubber base composition and mixing and dispersing the mixture using a dispersion device. In addition, silica and a solvent may be blended into the silicone rubber base composition at the same timing as carbon black is added.

A dispersion machine that is commonly used for dispersing pigments and the like can be used as the dispersion device. For example, mixers such as dispersers, homomixers, planetary mixers, homogenizers (“Clare Mix” manufactured by M Technique Co., Ltd., “Fill Mix” manufactured by PRIMIX, and the like, “Abra Mix” manufactured by Silverson, and the like), paint conditioners (manufactured by Red Devil), colloid mills (“PUC Colloid Mill” manufactured by PUC, “Colloid Mill MK” manufactured by IKA, and the like), media-type dispersers such as corn mills (for example, “Corn Mill MKO” manufactured by IKA, and the like), ball mills, sand mills (for example, “Dinomill” manufactured by Sinmaru Enterprises Corporation), attritors, pearl mills (for example, “DCP Mill” manufactured by Eirich Co., Ltd., and the like), and Kobor Mill, media-less dispersion machine such as wet jet mills (“Genas PY” manufactured by Genas Corporation, “Star Burst” manufactured by Sugino Machine Ltd., “Nanomizer” manufactured by NANOMIZER Inc., and the like), “Claire SS-5” manufactured by M Technique, Co., Ltd., and “MICROS” manufactured by NARA MACHINRY CO., LTD., and the like, three rolls (“BR-150VIII” manufactured by AIMEX CO., Ltd, and the like), and other roll mills, bead mills, and the like. However, the present invention is not limited thereto.

The conductive paste composition of the present embodiment includes: carbon black having a porous structure and having a DBP oil absorption amount of greater than 240 mL/100 g and a specific surface area of greater than 350 m²/g; and a liquid silicone rubber base composition, so that it is possible to form a conductive film which can be elastically deformed and is hardly damaged even stretching and contracting are repeated. Therefore, according to the conductive paste composition of the present embodiment, it is possible to provide an electrically resistant sensor with excellent sensing stability.

[Tear Strength]

When a tear strength of the conductive film, which is obtained by applying the conductive paste composition of the above-described embodiment and curing at 180° C. for two hours, is 15 kN/m or greater, it is possible to form a conductive film which can be elastically deformed and is hardly damaged even when the stretching and contracting are repeated. The tear strength was measured in accordance with JIS K6252-1 (crescent-shaped test piece). The unit of the tear strength is kN/m.

[Conductive Film]

The conductive film of the present embodiment is formed of the conductive paste composition of the above-described embodiment. The conductive film of the present embodiment can be obtained, for example, by applying the conductive paste composition of the above-described embodiment onto a base material or the like and drying the conductive paste composition.

The base material is not particularly limited as long as it can form the conductive film using the conductive paste composition described above, but examples thereof include resins such as a polyester such as silicone rubber, polyethylene terephthalate, or polyethylene naphthalate, polycarbonate, polyimide, polyurethane, polyester urethane, an acrylic resin, paper, a phenol resin, a urea resin, a melamine resin, an epoxy resin, and the like, rubbers, or films including elastomers. Preferred base material include a silicone rubber. Since the silicone rubber has excellent elasticity and biocompatibility, it is the most suitable material for sensing applications targeting living organisms such as humans or pets, which are assumed to be used.

In the conductive film of the present embodiment, the content of carbon black is 4% by mass or greater and 24% by mass or less, more preferably 7% by mass or greater and 13% by mass or less, and still more preferably 8% by mass or greater and 11% by mass or less. When the content of carbon black is less than the lower limit, a predetermined conductivity cannot be exhibited and sufficient sensing stability cannot be secured. When the content of carbon black exceeds the upper limit, the content of the carbon black to be blended becomes high. Therefore, flexibility of the obtained conductive film is impaired, and the sensing stability may not be secured.

The content of carbon black in the conductive film of the present embodiment is measured in the same manner as a method for measuring a content of carbon black in the conductive film, which is formed by drying and curing the above-described conductive paste composition at 180° C. for 2 hours.

The conductive film of the present embodiment has a surface resistance of 1 kΩ or greater and 9 kΩ or less, preferably 2 kΩ or greater and 8 kΩ or less, and more preferably 3 kΩ or greater and 7 kΩ or less. When the surface resistance of the conductive film is within the above range, it can be used as the sensing unit of the sensor of the present embodiment.

The surface resistance of the conductive film of the present embodiment is measured in the same manner as a method for measuring a surface resistance of carbon black in the conductive film, which is formed by drying and curing the above-described conductive paste composition at 180° C. for 2 hours.

The conductive film of the present embodiment has a resistance change rate of preferably less than 2% and more preferably less than 1.0%, during repeated stretching and contracting strain ((length after pulling−length before pulling)/length before pulling×100) of 0.5% to 5.0%. When the resistance change rate during repeated stretching and contracting with the strain of 0.5% to 5.0% in the conductive film exceeds the upper limit, sensing stability may not be secured.

The sensing stability against strain during repeated stretching and contracting with the strain of 0.5% to 5.0% in the conductive film of the present embodiment is evaluated as follows: (A) Stability under 0% strain (change in surface resistance when strain is 0% before and after repeated deformation), (B) Stability under (0.5% to 5.0%) strain (change in surface resistance during strain (0.5% to 5.0%) immediately after the deformation and after the repeated deformation), and (C) Goodness of sensing sensitivity when the strain is applied (reproducibility, presence/absence of noise).

The surface resistance is obtained by measuring the surface resistance of the conductive film, which is formed by drying and curing the conductive paste composition of the present embodiment at 180° C. for 2 hours, using a constant current type resistance measurement device.

The goodness of sensing sensitivity when the strain is applied during repeated stretching and contracting at the strain of 0.5% to 5.0% in the conductive film of the present embodiment was evaluated in consideration of the reproducibility of the obtained sensing sensitivity and the presence/absence of noise.

In the conductive film of the present embodiment, a resistance change rate ((R−R0)/(R0)×100) (hereinafter, “(R−R0” is represented as “AR”), which is defined as a ratio of the number of increases of a surface resistance (R) after temperature change (a humidity 60%, a temperature of higher than 10° C. and 50° C. or lower) with respect to a surface resistance (R0) before temperature change (a humidity 60%, a temperature 10° C.), is preferably 5% or less, and more preferably 4% or less at a humidity of 60% and a temperature of 10° C. or higher and 50° C. or lower. When the resistance change rate (ΔR−R0) is the upper limit or less, the conductive film is not easily affected by the temperature and has excellent sensing stability. For example, when assuming sensing of a living body, even if the sensor is warmed by the heat of the living body, stable sensing is possible.

The resistance change rate (ΔR/R0) in the conductive film of the present embodiment is evaluated by measuring the surface resistance (R) at each temperature of 10° C., 20° C., 30° C., 40° C., and 50° C. at a humidity of 60% using the change rate ((R−R0)/R0) of the resistance with respect to the surface resistance (R0) at a humidity of 60% and a temperature of 10° C. The surface resistance was measured in the same manner as for the surface resistance of the conductive film.

Hardness of the conductive film of the present embodiment is preferably 55 to 65, more preferably 58 to 63, and still more preferably 59 to 62. When the hardness exceeds the upper limit, elasticity of the obtained conductive film is impaired, so that sensing stability cannot be secured. When the hardness is less than the lower limit, sufficient durability cannot be exhibited due to insufficient strength.

The hardness of the conductive film of the present embodiment is measured in accordance with a durometer type A (shore A) specified in JIS K6253.

Since the conductive film of the present embodiment is formed of the conductive paste composition of the above-described embodiment, the conductive film is elastically deformable and is hardly damaged even after repeated stretching and contracting. Therefore, according to the conductive film of the present embodiment, it is possible to provide an electrically resistant sensor with excellent sensing stability.

<Method for Producing Conductive Film>

The conductive film of the present embodiment is formed by applying the conductive paste composition of the above-described embodiment onto the base material or the like and drying the conductive paste composition.

The method for applying the conductive paste composition onto the base material and the like is not particularly limited, and a known method can be used. Specifically, examples of the method include a die coating method, a dip coating method, a roll coating method, a doctor coating method, a knife coating method, a spray coating method, a gravure coating method, a screen printing method, a printing method using a metal mask, a printing method using a stencil mask, and an electrostatic coating method. As a drying method of the applied conductive paste composition, dry standing, fan dryer, warm air dryer, infrared ray heater, far infrared ray heater, and the like can be used, but the present invention is not particularly limited thereto.

[Electrically Resistant Sensor]

The electrically resistant sensor of the present embodiment includes a sensing unit made of the conductive film of the above-described embodiment.

### First Embodiment

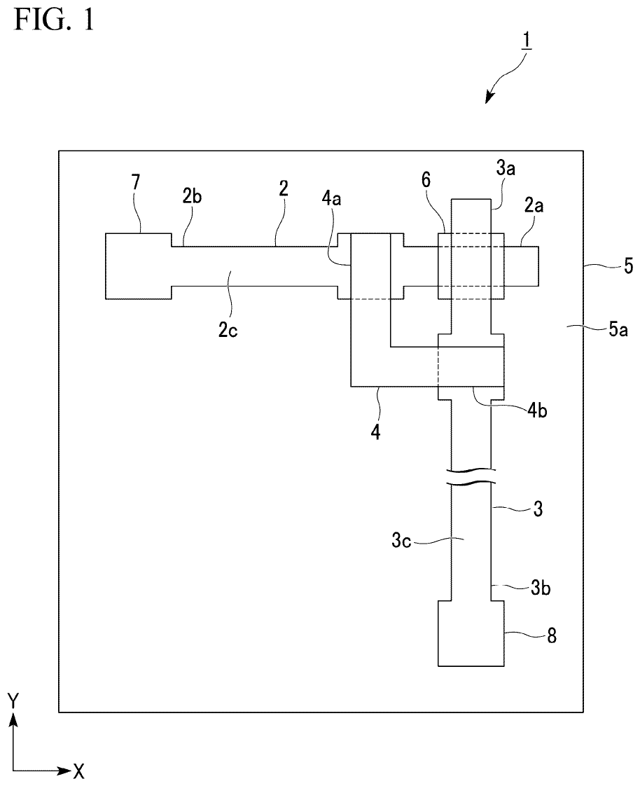

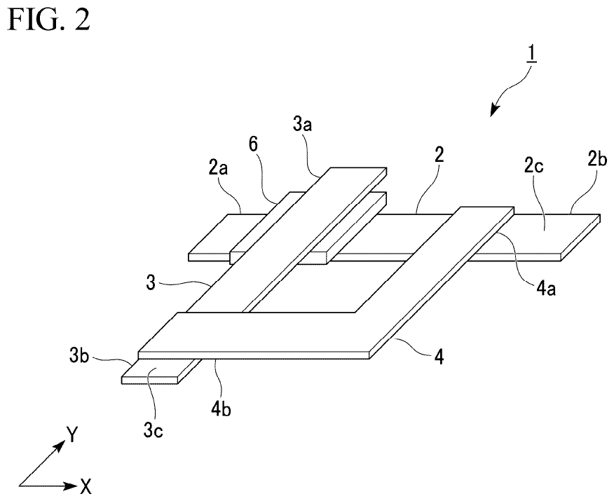

Hereinafter, the electrically resistant sensor of the present embodiment will be specifically described with reference to FIGS. 1 and 2.

FIG. 1 is a plan view showing the electrically resistant sensor of the present embodiment. FIG. 2 is a perspective view showing the electrically resistant sensor of the present embodiment.

As shown in FIGS. 1 and 2, an electrically resistant sensor 1 of the present embodiment includes a first electrode wire 2, a second electrode wire 3, and a resistor 4 including a conductive film.

The first electrode wire 2 is a band-shaped or linear wire extending in one direction (X direction in FIGS. 1 and 2) on an insulating base material 5 (surface 5a of the insulating base material 5).

The second electrode wire 3 is a band-shaped or linear wire extending the direction orthogonal to the one direction (Y direction in FIGS. 1 and 2) such that the second electrode wire 3 overlaps the first electrode wire 2 on the insulating base material 5 (surface 5a of the insulating base material 5).

The first electrode wire 2 and the second electrode wire 3 are orthogonal to each other via an insulator 6 at each of one end portions 2a and 3a, in plan view.

The first electrode wire 2 is formed with an electrode 7 which connects to an end portion (other end portion) 2b on an opposite side of the one end portion 2a that overlaps with the second electrode wire 3. The second electrode wire 3 is formed with an electrode 8 which connects to an end portion (other end portion) 3b on an opposite side of the one end portion 3a that overlaps with the first electrode wire 2. The electrodes 7 and 8 are connected to an external power source for applying a voltage to a resistor 4 including the conductive film.

The resistor 4 including the conductive film connects the first electrode wire 2 and the second electrode wire 3 at a portion where the first electrode wire 2 and the second electrode wire 3 do not overlap each other. Specifically, as shown in FIG. 2, one end portion 4a of the resistor 4 including the conductive film is connected to an upper surface 2c of the first electrode wire 2 in a thickness direction (thickness direction of the first electrode wire 2, thickness direction of the second electrode wire 3). In addition, the other end portion 4b of the resistor 4 including the conductive film is located on an upper surface of the second electrode wire 3 in the thickness direction (thickness direction of the first electrode wire 2, thickness direction of the second electrode wire 3), and is connected to an upper surface or lower surface (upper surface in FIG. 2) 3c of the second electrode wire 3. The resistor 4 including the conductive film is a sensing unit of the electrically resistant sensor 1.

The resistor 4 including the conductive film may have an L shape, a linear shape, an arc shape, or the like in plan view. In terms of excellent sensing sensitivity, the resistor 4 including the conductive film preferably has an L shape in plan view. The sensing sensitivity is satisfactory of responsiveness from an object including presence/absence of noise.

The first electrode wires 2 and the second electrode wires 3 are made of silver paste and conductive paste. The silver paste and conductive paste used for the electrodes are preferably pastes that secure conductivity and elasticity, but the present invention is not limited thereto. Examples of the commercial products include DOTITE FA-333 manufactured by Fujikura Kasei Co., Ltd., DW-250H-5 manufactured by Toyobo Co., Ltd., REXALPHA RAF110S manufactured by Toyo Ink Corporation, more preferably DOTITE FA-353N and DOTITE XA-9469 manufactured by Fujikura KASEI Co., Ltd, ECCOBOND 56C manufactured by Henkel, ELEPASTE NP-I manufactured by TAIYO holdings, Co., Ltd, and the like. When a volume resistance obtained by drying the above silver paste is less than 9.9×10⁻⁴ Ω·cm, the conductive paste can be used without any problem. In addition, a conductive paste prepared by mixing metal particles into the silicone rubber base composition may be used.

Thicknesses of the first electrode wire 2 and the second electrode wire 3 are preferably 10 μm or greater and 500 μm or less, and more preferably 50 μm or greater and 300 μm or less. When the thicknesses of the first electrode wires 2 and the second electrode wires 3 are within the above range, the electrically resistant sensor 1 has excellent sensing sensitivity.

The resistor 4 including the conductive film is made of the conductive film of the above-described embodiment. A thickness of the resistor 4 including the conductive film is preferably 20 μm or greater and 80 μm or less, and more preferably 30 μm or greater and 70 μm or less. When the thickness of the resistor 4 including the conductive film is within the above range, the electrically resistant sensor 1 will be excellent in sensing stability.

The material of the insulating base material 5 is not particularly limited, but examples thereof include resins such as a polyester such as silicone rubber, polyethylene terephthalate, or polyethylene naphthalate, polycarbonate, polyimide, polyurethane, polyester urethane, an acrylic resin, paper, a phenol resin, a urea resin, a melamine resin, an epoxy resin, and the like, rubbers, or films including elastomers. Preferred base material include a silicone rubber. Since the silicone rubber has excellent elasticity and biocompatibility, it is the most suitable material for sensing applications targeting living organisms such as humans or pets, which are assumed to be used.

The material of the insulator 6 is not particularly limited, but examples thereof include heat-curable elastomer and rubber. Specific examples thereof include silicone rubber, polyurethane rubber, phenol resin, urea resin, melamine resin, and epoxy resin.

The resistor 4 including the conductive film that connects the first electrode wire 2 and the second electrode wire 3 is elastically deformed by an external stress (in particular, a force in a thickness direction of the first electrode wire 2, the second electrode wire 3, and the resistor 4 including the conductive film), thereby changing the surface resistance. The electrically resistant sensor 1 of the present embodiment can detect a change in strain by using the change in the surface resistance. The surface resistance of the resistor 4 including the conductive film can be measured by changing a voltage, which is applied to the resistor 4 including the conductive film, via the electrode 7 provided on the first electrode wire 2 and the electrode 8 provided on the second electrode wire 3.

In the electrically resistant sensor 1 of the present embodiment, the resistor 4 including the conductive film connects the first electrode wire 2 and the second electrode wire 3, which are orthogonal to each other, at a portion that do not overlap each other, and the resistor 4 including the conductive film is formed of the conductive paste composition of the above-described embodiment. Therefore, the electrically resistant sensor 1 of the present embodiment has excellent sensing stability.

<Method for Manufacturing Electrically Resistant Sensor>

The method for manufacturing an electrically resistant sensor according to the present embodiment includes the steps of: forming a first electrode wire, forming a resistor including a conductive film, forming an insulator, and forming a second electrode wire.

Hereinafter, the method for manufacturing the electrically resistant sensor of the present embodiment will be specifically described with reference to FIGS. 1 and 2.

In the step of forming the first electrode wire, silver paste or conductive paste is applied to the surface 5a of the insulating base material 5, and the applied silver paste or conductive paste is dried and cured. Accordingly, the first electrode wire 2 is formed having a predetermined width, length, and thickness.

As the method of applying silver paste or conductive paste to the surface 5a of the insulating base material 5, a method for applying the conductive paste composition of the above-described embodiment can be used.

As a method of drying and curing the applied silver paste or conductive paste, a method for drying and curing the conductive paste composition of the above-described embodiment can be used.

In the step of forming the resistor including the conductive film, the resistor 4 is formed as follows. The conductive paste composition of the above-described embodiment is applied to the surface 5a of the insulating base material 5 and the upper surface 2c of the first electrode wire 2 such that one end portion 4a of the resistor 4 including the conductive film is connected to the upper surface 2c of the first electrode wire 2 and the other end portion 4b of the resistor 4 including the conductive film is connected to the upper surface or the lower surface (upper surface in FIGS. 1 and 2) 3c of the second electrode wire 3. After drying the applied conductive paste composition to obtain a conductive film, the resistor 4 including the conductive film having a predetermined shape (width and length) and thickness is formed. One end portion 4a of the resistor 4 including the conductive film is connected to a portion where the first electrode wire 2 that does not overlap the second electrode wire 3.

As the method of applying the conductive paste composition to the surface 5a of the insulating base material 5 and the upper surface 2c of the first electrode wire 2, the method for applying the conductive paste composition of the above-described embodiment can be used.

As a method of drying and curing the applied conductive paste composition, a method for drying and curing the conductive paste composition of the above-described embodiment can be used.

In the step of forming the insulator, a paste containing an insulating material is applied to a portion of the upper surface 2c of the first electrode wire 2 that overlaps the second electrode wire 3, and the applied paste is dried and cured to form an insulator 6 having a predetermined shape (width and length) and thickness.

As the method for applying the paste including the insulating material onto the upper surface 2c of the first electrode wire 2, the method for applying the conductive paste composition of the above-described embodiment can be used.

As the method for drying and curing the paste including the insulating material, the method for drying the conductive paste composition of the above-described embodiment can be used.

In the step of forming the second electrode wire, the silver paste or conductive paste is applied onto the surface 5a of the insulating base material 5 and the other end portion 4b of the resistor 4 including the conductive film, and the paste is dried and cured to form the second electrode wires 3 having a predetermined width, length, and thickness.

As the method of applying silver paste or conductive paste onto the surface 5a of the insulating base material 5 and the other end portion 4b of the resistor 4 including the conductive film, a method for applying the conductive paste composition of the above-described embodiment can be used.

As a method of drying and curing the applied silver paste or conductive paste, a method for drying and curing the conductive paste composition of the above-described embodiment can be used.

### Second Embodiment

Hereinafter, the electrically resistant sensor of the present embodiment will be specifically described with reference to FIGS. 1 to 3.

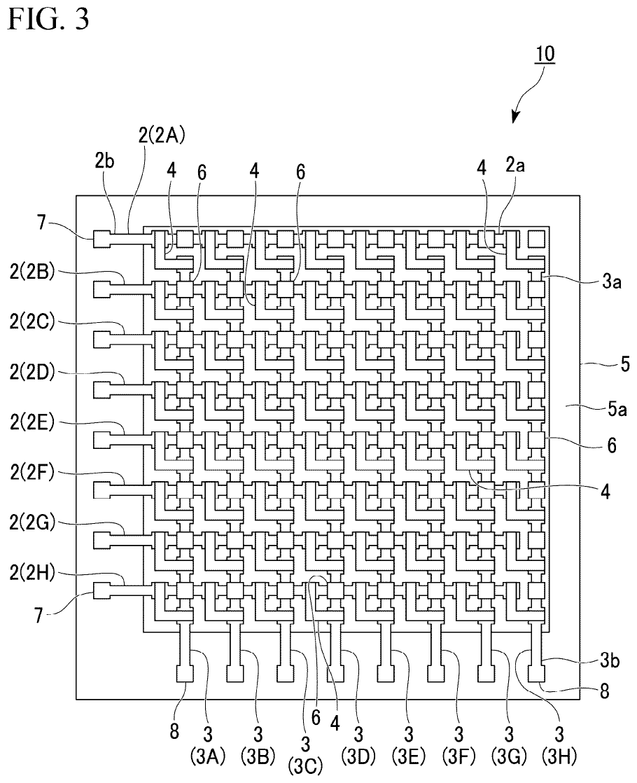

FIG. 3 is a plan view showing the electrically resistant sensor of the present embodiment. In the present embodiment, portions that are the same as components in the first embodiment will be given the same reference numerals and descriptions thereof will be omitted, and only points that differ will be described.

As shown in FIG. 3, an electrically resistant sensor 10 of the present embodiment includes a first electrode wire 2, a second electrode wire 3, and a resistor 4 including a conductive film.

Each of the first electrode wire 2 and the second electrode wire 3 includes a plurality of electrode wires provided in parallel and at equal intervals.

In FIG. 3, the first electrode wire 2 includes eight electrode wires 2A to 2G provided in parallel. In other words, an electrode wire 2A is a first column of the first electrode wire 2, an electrode wire 2B is a second column of the first electrode wire 2, and an electrode wire 2C is a third column of the first electrode wire 2, an electrode wire 2D is a fourth column of the first electrode wire 2, an electrode wire 2E is a fifth column of the first electrode wire 2, an electrode wire 2F is a sixth column of the first electrode wire 2, and an electrode wire 2G is a seventh column of the first electrode wire 2, and an electrode wire 2H is an eighth column of the first electrode wire 2.

The second electrode wire 3 includes eight electrode wires 3A to 3G provided in parallel. In other words, an electrode wire 3A is a first row of the second electrode wire 3, an electrode wire 3B is a second row of the second electrode wire 3, and an electrode wire 3C is a third row of the second electrode wire 3, an electrode wire 3D is a fourth row of the second electrode wire 3, an electrode wire 3E is a fifth row of the second electrode wire 3, an electrode wire 3F is a sixth row of the second electrode wire 3, and an electrode wire 3G is a seventh row of the second electrode wire 3, and an electrode wire 3H is an eighth row of the second electrode wire 3.

An interval between the electrode wires 2A to 2G and an interval between the electrode wires 3A to 3G are not particularly limited, but are appropriately determined according to desired sensing sensitivity.

The electrically resistant sensor 10 of the present embodiment includes the first electrode wire 2 including eight electrode wires 2A to 2G provided in parallel in one direction (X direction shown in FIG. 3), the second electrode wire including eight electrode wires 3A to 3G provided in parallel in a direction orthogonal to the one direction (Y direction shown in FIG. 3) so as to overlap the first electrode wire 2, and the resistor 4 including the conductive film that connects the first electrode wire 2 and the second electrode wire 3 at a portion where the first electrode wire 2 and the second electrode wire 3 overlap each other.

For example, the electrode wire 2B, which is the second column of the first electrode wire 2, and the electrode wire 3C, which is the third row of the second electrode wire 3, are orthogonal to each other via the insulator 6, and the electrode wires 2B and 3C are connected by the resistor 4 including the conductive film having an L shape in plan view at a portion where the electrode wires 2B and 3C do not overlap each other. In addition, the electrode wire 2E, which is the fifth column of the first electrode wire 2, and the electrode wire 3G, which is the seventh row of the second electrode wire 3, are orthogonal to each other via the insulator 6, and the electrode wires 2E and 3G are connected by the resistor 4 including the conductive film having an L shape in plan view at a portion where the electrode wires 2E and 3G do not overlap each other. In addition, the electrode wire 2H, which is the eight column of the first electrode wire 2, and the electrode wire 3D, which is the fourth row of the second electrode wire 3, are orthogonal to each other via the insulator 6, and the electrode wires 2H and 3D are connected by the resistor 4 including the conductive film having an L shape in plan view at a portion where the electrode wires 2H and 3D do not overlap each other. In this manner, the electrically resistant sensor 10 of the present embodiment forms a lattice shape with the eight first electrode wires 2 and the eight second electrode wires 3. As such, the lattice shape is formed by the first electrode wire 2 and the second electrode wire 3, so that the resistor 4 including the conductive film, which is the sensing unit, can be densely provided.

The first electrode wire 2 is formed with the electrode 7 which is connected to an end portion (other end portion) 2b on an opposite side of one end portion 2a connected to the resistor 4 including the conductive film. The second electrode wire 3 is formed with the electrode 8 which is connected to an end portion (other end portion) 3b on an opposite side of one end portion 3a connected to the resistor 4 including the conductive film.

In the present embodiment, a case where the first electrode wire 2 includes eight electrode wires 2A to 2G and the second electrode wire 3 includes eight electrode wires 3A to 3G, has been shown, but the electrically resistant sensor of the present invention is not limited thereto. In the electrically resistant sensor of the present invention, the first electrode wire and the second electrode wire may include two or more, seven or less, or nine or more electrode wires. By increasing the number and area of electrode wires, so that it is possible to sense large objects such as human bodies and structures. In addition, the present invention uses thin and flexible base material, so that sensing is possible in a state where a shape thereof is attached in a spherical shape or other three-dimensional shape. In the electrically resistant sensor of the present invention, it is preferable that the number of the first electrode wires and the number of the second electrode wires is four or greater in terms of excellent sensing sensitivity.

Even in the electrically resistant sensor 10 of the present embodiment, the resistor 4 including the conductive film is elastically deformed by an external stress (in particular, a force in a thickness direction of the first electrode wire 2, the second electrode wire 3, and the resistor 4 including the conductive film), thereby changing the surface resistance. The electrically resistant sensor 10 of the present embodiment can detect a change in strain by using the change in the surface resistance. The surface resistance of the resistor 4 including the conductive film can be measured by changing a voltage, which is applied to the resistor 4 including the conductive film, via the electrode 7 provided on the first electrode wire 2 and the electrode 8 provided on the second electrode wire 3.

In the electrically resistant sensor 10 of the present embodiment, the resistor 4 including the conductive film connects the first electrode wire 2 and the second electrode wire 3, which are orthogonal to each other, at a portion that do not overlap each other, and the resistor 4 including the conductive film is formed of the conductive paste composition of the above-described embodiment, and thus excellent sensing stability is obtained. In addition, the electrically resistant sensor 10 of the present embodiment includes the first electrode wire 2 including eight electrode wires 2A to 2G, the second electrode wire 3 including eight electrode wires 3A to 3G, and the resistor 4 including a plurality of conductive films for connecting the electrode wires 2A to 2G and the electrode wires 3A to 3G. Since the resistor 4 including the conductive film as the sensing unit is densely provided, sensing sensitivity is superior to that of an electrically resistant sensor 1 having each of the first electrode wire 2 and the second electrode wire 3.

The electrically resistant sensor of the present embodiment can be manufactured by a manufacturing method similar to that of the first embodiment described above.

An electrical resistant sensor of the present embodiment includes one or greater layers of a sheet-like sensor. For example, when an object to be sensed is made of a hard material, the number of places to which the sensor responds can be increased by multilayering and stacking the sensor densely in the plane, and sensing sensitivity can be improved.

### Third Embodiment

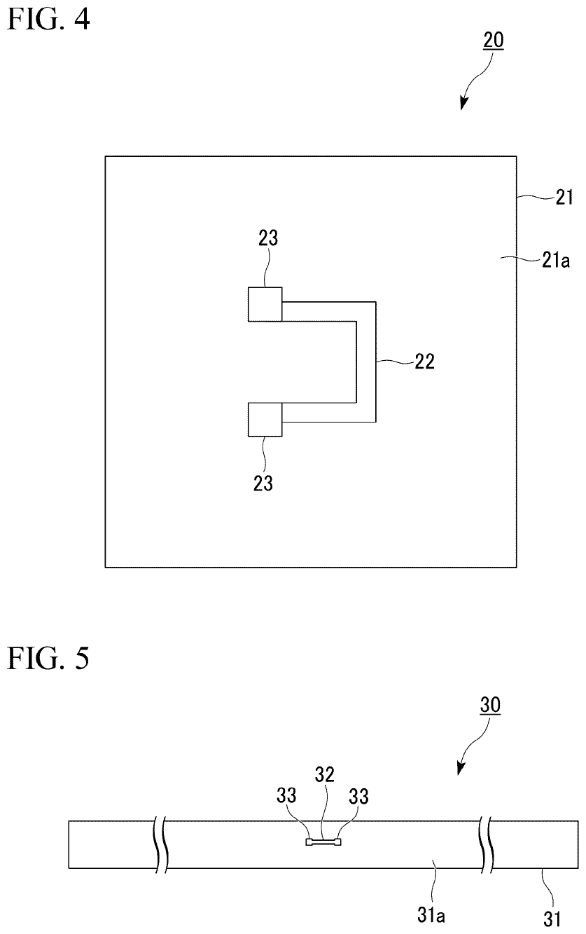

Hereinafter, the electrically resistant sensor of the present embodiment will be specifically described with reference to FIG. 4.

FIG. 4 is a plan view showing the electrically resistant sensor of the present embodiment.

As shown in FIG. 4, an electrically resistant sensor 20 of the present embodiment includes an insulating base material 21 and a strain measurement unit 22 formed on the insulating base material 21 (surface 21a of the insulating base material 21).

A shape of the insulating base material 21 is not particularly limited, but the surface 21a of the insulating base material 21 is preferably a flat surface in order for the strain measurement unit 22 formed of the conductive film to have excellent sensing sensitivity.

The strain measurement unit 22 has a U shape in plan view. The strain measurement unit 22 is a sensing unit of the electrically resistant sensor 20. Electrodes 23 connected to the strain measurement unit 22 are formed on both end portions of the strain measurement unit 22.

The insulating base material 21 can be elastically deformed. The insulating base material that can be elastically deformed is not particularly limited, but examples thereof include resins such as a polyester such as silicone rubber, polyethylene terephthalate, or polyethylene naphthalate, polycarbonate, polyimide, polyurethane, polyester urethane, an acrylic resin, paper, a phenol resin, a urea resin, a melamine resin, an epoxy resin, and the like, rubbers, or films including elastomers.

The strain measurement unit 22 is made of the conductive film of the above-described embodiment.

The electrodes 23 includes silver paste or conductive paste. Although not particularly limited, examples of the commercial materials include DOTITE FA-333 manufactured by Fujikura Kasei Co., Ltd., DW-250H-5 manufactured by Toyobo Co., Ltd, REXALPHA RAF110S manufactured by Toyo Ink Corporation, more preferably DOTITE FA-353N and DOTITE XA-9469 manufactured by Fujikura KASEI Co., Ltd, ECCOBOND 56C manufactured by Henkel, ELEPASTE NP-1 manufactured by TAIYO holdings, Co., Ltd, and the like.

In the present embodiment, a case where one strain measurement unit 22 is provided has been exemplified, but the electrically resistant sensor of the present invention is not limited thereto. The electrically resistant sensor of the present invention may include two or more strain measurement units.

In the electrically resistant sensor 20 of the present embodiment, because the insulating base material 21 is elastically deformed, the strain measurement unit 22 formed on the surface 21a of the insulating base material 21 is elastically deformed by an external stress (particularly, a force in a thickness direction of the insulating base material 21 and the strain measurement unit 22). The strain measurement unit 22 is deformed by an external stress, thereby changing a surface resistance. The electrically resistant sensor 20 of the present embodiment can detect a change in strain by using the change in the surface resistance. A change in the surface resistance of the strain measurement unit 22 can be measured by a change in voltage applied to the strain measurement unit 22 via electrodes 23 provided at both end portions of the strain measurement unit 22.

The electrically resistant sensor 20 of the present embodiment has excellent sensing sensitivity because the strain measurement unit 22 that is elastically deformed is formed on the surface 21a of the insulating base material 21 that is elastically deformed.

<Method for Manufacturing Electrically Resistant Sensor>

A method for manufacturing the electrically resistant sensor of the present embodiment includes a step of forming a resistor using a conductive film obtained by drying the conductive paste.

Hereinafter, the method for manufacturing the electrically resistant sensor of the present embodiment will be specifically described with reference to FIG. 4.

In the step of forming the resistor including the conductive film, the conductive paste composition of the above-described embodiment is applied to the surface 21a of the insulating base material 21, and the applied conductive paste composition is dried and cured to form the strain measurement unit 22 having a predetermined shape (width and length) and thickness.

As a method of applying a conductive paste composition to the surface 21a of the insulating base material 21, a method for applying the conductive paste composition of the above-described embodiment can be used.

As a method of drying and curing the applied conductive paste composition, a method for drying and curing the conductive paste composition of the above-described embodiment can be used.

### Fourth Embodiment

Hereinafter, the electrically resistant sensor of the present embodiment will be specifically described with reference to FIG. 5.

FIG. 5 is a plan view showing the electrically resistant sensor of the present embodiment.

As shown in FIG. 5, an electrically resistant sensor 30 of the present embodiment includes an insulating base material 31 and a strain measurement unit 32 formed on the insulating base material 31 (surface 31a of the insulating base material 31).

A shape of the insulating base material 31 is not particularly limited, but the surface 31a of the insulating base material 31 is preferably a flat surface in order for the strain measurement unit 32 formed of the conductive film to have excellent sensing sensitivity.

The strain measurement unit 32 has a linear shape in plan view. The strain measurement unit 32 is a sensing unit of the electrically resistant sensor 30. Electrodes 33 connected to the strain measurement unit 32 are formed on both end portions of the strain measurement unit 32.

The insulating base material 31 can be elastically deformed. The insulating base material that can be elastically deformed is not particularly limited, but examples thereof include resins such as a polyester such as silicone rubber, polyethylene terephthalate, or polyethylene naphthalate, polycarbonate, polyimide, polyurethane, polyester urethane, an acrylic resin, paper, a phenol resin, a urea resin, a melamine resin, an epoxy resin, and the like, rubbers, or films including elastomers.

The strain measurement unit 32 is made of the conductive film of the above-described embodiment.

The electrodes 33 includes silver paste or conductive paste. Although not particularly limited, examples of the commercial materials include DOTITE FA-333 manufactured by Fujikura Kasei Co., Ltd., DW-250H-5 manufactured by Toyobo Co., Ltd, REXALPHA RAF110S manufactured by Toyo Ink Corporation, more preferably DOTITE FA-353N and DOTITE XA-9469 manufactured by Fujikura KASEI Co., Ltd, ECCOBOND 56C manufactured by Henkel, ELEPASTE NP-1 manufactured by TAIYO holdings, Co., Ltd, and the like.

In the present embodiment, a case where one strain measurement unit 32 is provided has been exemplified, but the electrically resistant sensor of the present invention is not limited thereto. The electrically resistant sensor of the present invention may include two or more strain measurement units that are provided continuously in a row in the same direction.

In the electrically resistant sensor 30 of the present embodiment, because the insulating base material 31 is elastically deformed, the strain measurement unit 32 formed on the surface 31a of the insulating base material 31 is elastically deformed by an external stress (particularly, a force in a thickness direction of the insulating base material 31 and the strain measurement unit 32). The strain measurement unit 32 is deformed by an external stress, thereby changing a surface resistance. The electrically resistant sensor 30 of the present embodiment can detect a change in strain by using the change in the surface resistance. A change in the surface resistance of the strain measurement unit 32 can be measured by a change in voltage applied to the strain measurement unit 32 via electrodes 33 provided at both end portions of the strain measurement unit 32.

The electrically resistant sensor 30 of the present embodiment has excellent sensing sensitivity because the strain measurement unit 32 that is elastically deformed is formed on the surface 31a of the insulating base material 31 that is elastically deformed.

<Method for Manufacturing Electrically Resistant Sensor>

A method for manufacturing the electrically resistant sensor of the present embodiment includes a step of forming a resistor using a conductive film obtained by drying and curing the conductive paste.

Hereinafter, the method for manufacturing the electrically resistant sensor of the present embodiment will be specifically described with reference to FIG. 5.

In the step of forming the resistor obtained from the conductive film, the conductive paste composition of the above-described embodiment is applied to the surface 31a of the insulating base material 31, and the applied conductive paste composition is dried and cured to form the strain measurement unit 32 having a predetermined shape (width and length) and thickness.

As a method of applying a conductive paste composition to the surface 31a of the insulating base material 31, a method for applying the conductive paste composition of the above-described embodiment can be used.

As a method of drying and curing the applied conductive paste composition, a method for drying and curing the conductive paste composition of the above-described embodiment can be used.

### EXAMPLES

Hereinafter, the present invention will be described in more detail with reference to Examples and Comparative Examples, but the present invention is not limited to the following Examples.

### Example 1

“Preparation of Conductive Paste Composition”

The following materials were used as a carbon material (A) and a liquid silicone rubber base composition (B). In addition, Tables 1 and 2 show a content of the carbon material (A) as a value with respect to 100 parts by mass of the liquid silicone rubber base composition (B).

Carbon material (A-1): 3 parts by mass of Lionite EC200L (DBP oil absorption amount: 255 mL/100 g, specific surface area: 380 m²/g) manufactured by LION SPECIALTY CHEMICALS CO., Ltd.

A prepared liquid silicone rubber base composition (B-1) was blended with the carbon material (A-1) and kneaded using a triple roll to obtain a conductive paste composition.

TABLE 1

| | | | | | Example 1 | Example 2 | Example 3 | Example 4 | Example 5 | Example 6 | Example 7 | Example 8 | Example 9 |
|---|---|---|---|---|---|---|---|---|---|---|---|---|---|
| A | Carbon | A-1 | Lionite EC200L | LION SPECIALTY | 3 | — | — | — | — | — | — | — | — |
| | material | A-2 | Ketjenblack EC300J | CHEMICALS CO., Ltd. | — | 3 | — | — | — | — | — | — | — |
| | | A-3 | Ketjenblack EC600JD | | — | | 3 | 3 | 3 | 3 | — | — | 2 |
| | | A-4 | BlackPearls 2000 | Cabot Japan Corporation | — | — | — | — | — | — | 3 | — | — |
| | | A-5 | chezacarb AC-60 | Unipetrol | — | — | — | — | — | — | — | 3 | — |
| | | A-6 | Denka black HS-100 | Denka Company Limited | — | — | — | — | — | — | — | — | — |
| | | A-7 | MWCNT 901019 | Sigma-Aldrich Japan K.K. | — | — | — | — | — | — | — | — | — |
| B | Silicone | B-1 | | | 100 | 100 | 100 | — | — | — | 100 | 100 | 100 |
| | rubber base | B-2 | | | — | — | — | 100 | — | — | — | — | — |
| | composition | B-3 | | | — | — | — | — | 100 | — | — | — | — |
| | | B-4 | | | — | — | — | — | — | 100 | — | — | — |
| | | B-5 | | | — | — | — | — | — | — | — | — | — |
| | | B-6 | | | — | — | — | — | — | — | — | — | — |

| Conductivity after drying (kΩ) | | | 1 kΩ to 9 kΩ | 8.4 | 6.2 | 4.5 | 5.5 | 4.7 | 5.2 | 4.7 | 4.8 | 7.3 |
|---|---|---|---|---|---|---|---|---|---|---|---|---|
| Hardness of conductive film | | | 55 to 65 | 55 | 58 | 60 | 55 | 56 | 65 | 62 | 61 | 55 |
| Proportion of carbon material after drying (%) | | | 4 to 24% | 9.1 | 9.1 | 9.1 | 9.1 | 9.8 | 8.2 | 9.1 | 9.1 | 6.3 |
| Sensing stability against temperature (%) | | Temperature 10° C. | 5% or less | 0.05 | 0.03 | 0.02 | 0.05 | 0.04 | 0.03 | 0.03 | 0.03 | 0.05 |
| | | Temperature 23° C. | 5% or less | 0.7 | 0.5 | 0.3 | 0.6 | 0.8 | 0.5 | 0.4 | 0.3 | 0.4 |
| | | Temperature 50° C. | 5% or less | 4 | 2.5 | 0.6 | 4.3 | 4.7 | 1 | 1 | 0.9 | 3.5 |
| Sensing stability against strain (%) | | Strain 0.5% | Less than 2% | 0.7 | 0.5 | 0.3 | 0.7 | 0.8 | 0.6 | 0.4 | 0.4 | 0.7 |
| *when strain is 0% | | | | | | | | | | | | |
| Sensing stability against strain (%) | | | | 0.8 | 0.7 | 0.5 | 0.8 | 0.9 | 0.6 | 0.5 | 0.5 | 0.8 |
| *when strain is 0.5% | | | | | | | | | | | | |
| Goodness of | Reproducibility of sensitivity | | | B (0.3) | A (0.1) | A (0.1) | B (0.3) | B (0.4) | A (0.1) | A (0.2) | A (0.1) | B (0.4) |
| sensitivity when | Noise | | | A (0) | A (0) | A (0) | A (0) | A (0) | A (0) | A (2) | A (1) | A (0) |
| strain is applied | Comprehensive evaluation | | | B (Good) | A | A | B | B | A | A | A | B |
| Sensing stability against strain (%) | | Strain 5.0% | Less than 2% | 0.8 | 0.8 | 0.7 | 0.8 | 0.8 | 0.7 | 0.7 | 0.8 | 0.9 |
| *when strain is 0% | | | | | | | | | | | | |
| Sensing stability against strain (%) | | | | 1.2 | 1 | 0.3 | 1.5 | 1.8 | 0.4 | 0.4 | 0.3 | 1.5 |
| *when strain is 0.5% | | | | | | | | | | | | |
| Goodness of | Reproducibility of sensitivity | | | B (0.4) | A (0.2) | A (0.2) | B (0.4) | B (0.5) | A (0.3) | A (0.3) | A (0.3) | B (0.4) |
| sensitivity when | Noise | | | A (0) | A (0) | A (0) | A (0) | A (0) | A (0) | A (3) | A (2) | A (0) |
| strain is applied | Comprehensive evaluation | | | B (Good) | A | A | B | B | A | A | A | B |

| Elasticity of conductive film | | A | A | A | B | B | A | A | A | A |
|---|---|---|---|---|---|---|---|---|---|---|
| Tear strength (kN/m) | | 18 | 16 | 15 | 7 | 5 | 20 | 15 | 16 | 17 |
| Sensing sensitivity of pulse wave sensor | Sensing unit - alone | B | B | B | B | B | B | B | B | B |
| | Sensing unit - plural | B | A | A | B | B | A | A | A | B |
| Sensing sensitivity of surface pressure | | B | A | A | B | B | A | A | A | B |
| distribution sensor | | | | | | | | | | |
| Sensing sensitivity of acceleration sensor | | B | A | A | B | B | A | A | A | B |

TABLE 2

| | | | | | | | | | Comparative | Comparative | Comparative | Comparative |
|---|---|---|---|---|---|---|---|---|---|---|---|---|
| | | | | | Example 10 | Example 11 | Example 12 | Example 13 | Example 1 | Example 2 | Example 3 | Example 4 |
| A | Carbon | A-1 | Lionite EC200L | LION SPECIALTY | — | — | — | — | — | — | — | — |
| | material | A-2 | Kctjenblack EC300J | CHEMICALS CO., Ltd. | — | — | — | — | — | — | — | — |
| | | A-3 | Kctjenblack EC600JD | | 4 | 5 | 3 | 3 | — | — | 1 | 10 |
| | | A-4 | BlackPearls 2000 | Cabot Japan Corporation | — | — | — | — | — | — | — | — |
| | | A-5 | chezacarb AC-60 | Unipetrol | — | — | — | — | — | — | — | — |
| | | A-6 | Denka black HS-100 | Denka Company Limited | — | — | — | — | 15 | — | — | — |
| | | A-7 | MWCNT 901019 | Sigma-Aldrich Japan K.K. | — | — | — | — | — | 3 | — | — |
| B | Silicone rubber | B-1 | | | 100 | 100 | — | — | 100 | 100 | 100 | 100 |
| | base | B-2 | | | — | — | — | — | — | — | — | — |
| | composition | B-3 | | | — | — | — | — | — | — | — | — |
| | | B-4 | | | — | — | — | — | — | — | — | — |
| | | B-5 | | | — | — | 100 | — | — | — | — | — |
| | | B-6 | | | — | — | — | 100 | — | — | — | — |

| Conductivity after drying (kΩ) | | | 1 kΩ to 9 kΩ | 2.5 | 2 | 3.9 | 5.9 | 3.7 | 3.5 | 5000 | 0.03 |
|---|---|---|---|---|---|---|---|---|---|---|---|
| Hardness of conductive film | | | 55 to 65 | 63 | 65 | 62 | 58 | 68 | 59 | 53 | 75 |
| Proportion of carbon material after drying (%) | | | 4 to 24% | 11.8 | 14.3 | 10.5 | 8.1 | 33.3 | 9.1 | 3.2 | 25 |
| Sensing stability against temperature (%) | | Temperature 10° C. | 5% or less | 0.04 | 0.05 | 0.04 | 0.03 | 0.1 | 0.04 | Not | 0.08 |
| | | Temperature 23° C. | 5% or less | 0.4 | 0.4 | 0.5 | 0.4 | 3.5 | 0.3 | measured | 2.5 |
| | | Temperature 50° C. | 5% or less | 2.8 | 4 | 2 | 1.8 | 28 | 7 | | 10 |
| Sensing stability against strain (%) | | Strain 0.5% | Less than 2% | 0.6 | 0.8 | 0.5 | 0.4 | 1.5 | 1.7 | | 1.4 |
| *when strain is 0% | | | | | | | | | | | |
| Sensing stability against strain (%) | | | | 0.7 | 0.8 | 0.6 | 0.6 | 2.1 | 2.2 | | 2.8 |
| *when strain is 0.5% | | | | | | | | | | | |
| Goodness of | Reproducibility of sensitivity | | | B (0.4) | B (0.4) | A (0.2) | A (0.2) | C (0.7) | C (0.6) | | C (0.6) |
| sensitivity when | Noise | | | A (0) | A (1) | A (0) | A (0) | A (0) | C (>5) | | C (>5) |
| strain is applied | Comprehensive evaluation | | | B | B | A | A | C | C | | C |
| Sensing stability against strain (%) | | Strain 5.0% | Less than 2% | 0.8 | 0.9 | 0.7 | 0.7 | 1 | 1.2 | | 1.6 |
| *when strain is 0% | | | | | | | | | | | |
| Sensing stability against strain (%) | | | | 1.3 | 1.8 | 0.9 | 0.8 | 5 | 4.5 | | 7 |
| *when strain is 0.5% | | | | | | | | | | | |
| Goodness of | Reproducibility of sensitivity | | | B (0.5) | B (0.6) | A (0.3) | A (0.3) | C (1.1) | C (1.4) | | C (0.9) |
| sensitivity when | Noise | | | A (0) | A (0) | A (0) | A (0) | A (0) | C (>5) | | C (>5) |
| strain is applied | Comprehensive evaluation | | | B | B | A | A | C | C | | C |

| Elasticity of conductive film | | B | B | A | A | C | A | C |
|---|---|---|---|---|---|---|---|---|
| Tear strength (kN/m) | | 11 | 5 | 12 | 18 | 4 | 15 | 3 |
| Sensing sensitivity of pulse wave sensor | Sensing unit - alone | B | B | B | B | C | C | C |
| | Sensing unit - plural | B | B | A | A | C | C | C |
| Sensing sensitivity of surface pressure | | B | B | A | A | C | C | C |
| distribution sensor | | | | | | | | |
| Sensing sensitivity of acceleration sensor | | B | B | A | A | C | C | C |

“Preparation of Liquid Silicone Rubber Base Composition (B)”

The liquid silicone rubber base composition (B-i) was prepared with reference to Japanese Patent No. 2739415. In addition, the content of each component are shown in Table 3 by a value with respect to the total mass (100 parts by mass) of the liquid silicone rubber base composition (B-i). As shown in Table 3, the liquid silicone rubber base composition was obtained by blending a polysiloxane compound, silica, an inorganic filler modifier, a crosslinking agent, a catalyst, and a solvent.

TABLE 3

| | | |
|---|---|---|
| B-1 | Dimethylpolysiloxane oil containing vinyl groups at | 18.8 |
| | both ends (polysiloxane compound) | |
| | Silica | 8.5 |
| | Hexamethyldisilazane (inorganic filler modifier) | 1.9 |
| | Water | 0.4 |
| | Methylhydrodienepolysiloxane (crosslinking agent) | 0.4 |
| | 2% 2-Ethylhexanol solution of chloroplatinic acid (catalyst) | 0.03 |
| | Tridecane (solvent) | 70 |
| B-2 | Dimethylpolysiloxane oil containing vinyl groups at | 26.3 |
| | both ends | |
| | Silica | — |
| | Hexamethyldisilazane | 2.6 |
| | Water | 0.5 |
| | Methylhydrodienepolysiloxane | 0.6 |
| | 2% 2-Ethylhexanol solution of chloroplatinic acid | 0.04 |
| | Tridecane | 70 |
| B-3 | SILPOT 184 | 25 |
| | CATALYST SILPOT 184 | 2.5 |
| | Silica | — |
| | Tridecane | 72.5 |
| B-4 | SILPOT 184 | 17 |
| | CATALYST SILPOT 184 | 1.7 |
| | Silica | 15 |
| | Tridecane | 66.3 |
| B-5 | Dimethylpolysiloxane oil containing vinyl groups at | 16.1 |
| | both ends | |
| | Silica | 7.3 |
| | Hexamethyldisilazane | 1.6 |
| | Water | 0.3 |
| | Methylhydrodienepolysiloxane | 0.3 |
| | 2% 2-Ethylhexanol solution of chloroplatinic acid | 0.03 |
| | Tridecane | 74.4 |
| B-6 | Dimethylpolysiloxane oil containing vinyl groups at | 21.5 |
| | both ends | |
| | Silica | 9.7 |
| | Hexamethyldisilazane | 2.1 |
| | Water | 0.4 |
| | Methylhydrodienepolysiloxane | 0.5 |
| | 2% 2-Ethylhexanol solution of chloroplatinic acid | 0.03 |
| | Tridecane | 65.8 |

Commercially available materials such as “SILPOT184” (B-3) manufactured by Dow & Toray Co., Ltd. described in Table 3 have already been blended with the crosslinking agent and the solvent. The silicone rubber base composition (B) was blended with the carbon material (A) and the curing agent, and when a viscosity thereof was high, a small amount of solvent was added as appropriate. A blending product was kneaded using a triple roll to obtain a conductive paste composition. In addition, silica was blended at a timing when the carbon material (A) was blended into the silicone rubber base composition (B-3) in order to appropriately improve tear strength (B-4).

“Method for Manufacturing Each Sensor”

“Method for Manufacturing Surface Pressure Distribution Sensor”

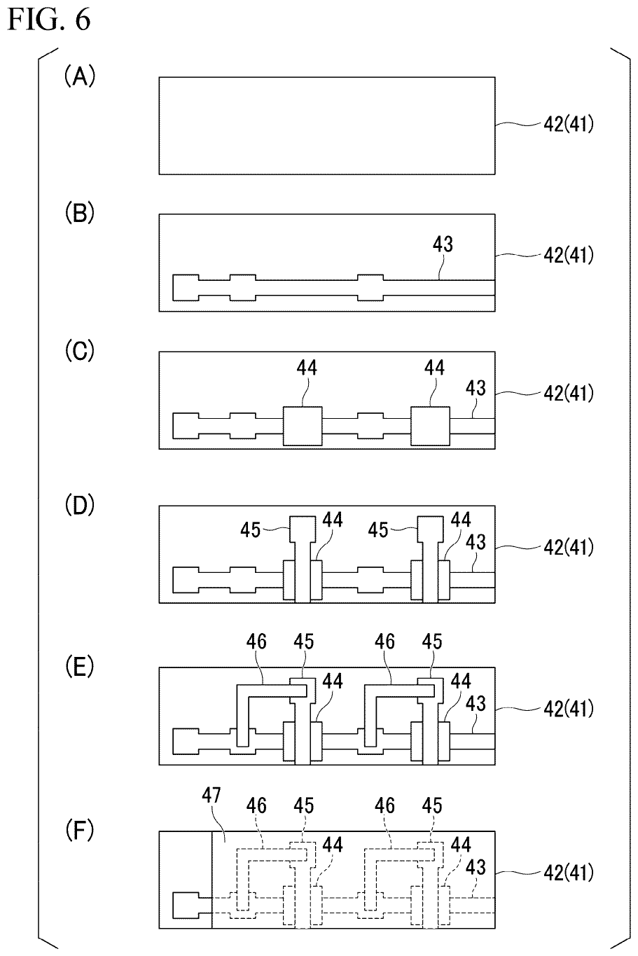

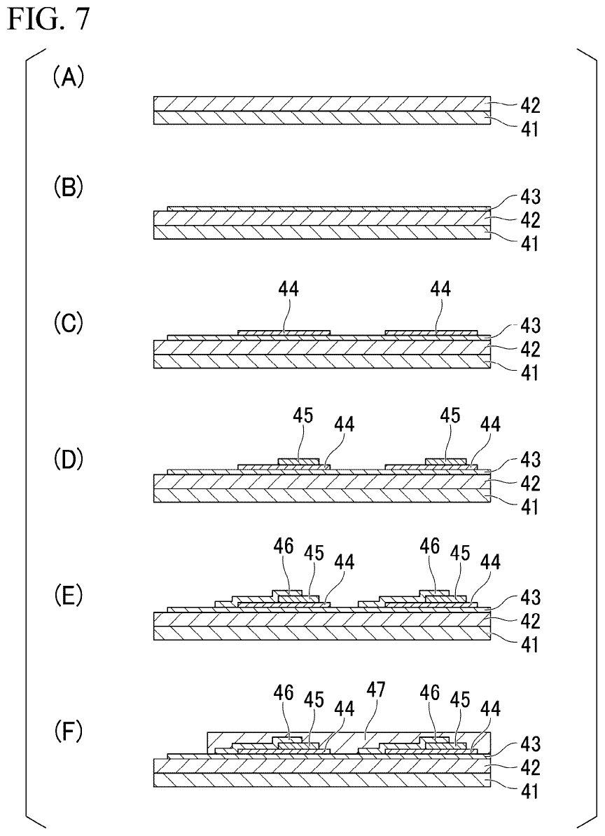

As shown in FIGS. 6(A) and 7(A), a PET film 41 was used as a base paper, and polydimethylsiloxane (hereinafter referred to as “PDMS”) (SILPOT184, manufactured by Dow & Toray Co., Ltd.) was used to perform stencil printing on the PET film 41 so as to have a size of 100 mm in length, 100 mm in width, and 0.5 mm in thickness or to perform a doctor coating method, and then the PET film 41 was dried and cured at 100° C. for 1 hour, thereby forming a base material 42 formed of PDMS.

As shown in FIGS. 6(B) and 7(B), a wire, which has a length of 82 mm, a width of 2 mm, and a thickness of 0.2 mm, was formed on the produced base material 42 including PDMS, and stencil printing was performed using silver paste (DOTITE XA-9469, manufactured by FUJIKURA KASEI CO., LTD) so as to have an interval of 10 mm on the wire, and then the wire was dried and cured at 100° C. for 1 hour, thereby forming a lower electrode 43.

As shown in FIGS. 6(C) and 7(C), an insulating layer, which has a length of 4 mm, a width of 4 mm, and a thickness of 0.25 mm, was formed by stencil printing using PDMS at an intersection between the produced lower electrode 43 and an upper electrode, and then the insulating layer was dried and cured at 100° C. for 1 hour, thereby forming an insulating layer 44.

As shown in FIGS. 6(D) and 7(D), silver paste (DOTITE XA-9469, manufactured by FUJIKURA KASEI CO., LTD) was formed on an upper layer of the produced insulating layer 44 to be orthogonal to the lower electrode 43 and to have a length of 82 mm, a width of 2 mm, and a thickness of 0.2 mm, stencil printing was performed on the silver paste, and then the silver paste was dried and cured at 100° C. for 1 hour, thereby forming an upper electrode 45.

As shown in FIGS. 6(E) and 7(E), the conductive paste composition was used to form a conductive film, which has a length of 14 mm, a width of 2 mm, and a thickness of 0.25 mm, on an upper layer of the produced upper electrode 45 by stencil printing such that the upper electrode 45 and the lower electrode 43 overlap in an L shape, and then the conductive film was dried and cured at 100° C. for 1 hour, thereby forming a conductive film 46.

As shown in FIGS. 6(F) and 7(F), a protective layer, which has a length of 80 mm, a width of 80 mm, and a thickness of 0.25 mm, was formed by the stencil printing using PDMS at an upper layer on which the conductive film 46 is formed, and then the protective layer was dried and cured at 100° C. for 1 hour, thereby forming a protective layer 47.

After forming the protective layer 47, the PET film 41 of the base paper was peeled off, a crosslinking treatment was performed at 180° C. for 2 hours, silver paste (ECCOBOND 56C, manufactured by Henkel) was used to attach a lead wire to the crosslinked upper electrode 45 and the lower electrode 43, and the lead wire was dried and cured at 150° C. for 15 minutes, thereby obtaining a surface pressure distribution sensor.

“Configuration Example of Surface Pressure Distribution Sensor”

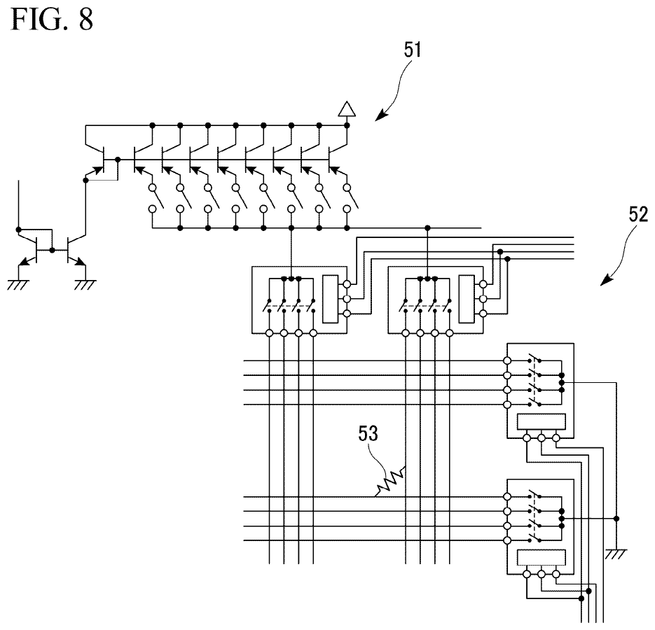

A control circuit 51 as shown in FIG. 8 was formed to be connected to the surface pressure distribution sensor 52. Pressure distribution when a pressure is applied to the surface pressure distribution sensor 52 was displayed on a personal computer. A resistance wire 53 shown in FIG. 8 is a conductive film obtained from the conductive paste composition described above.

“Configuration Example of Acceleration Sensor And Method for Manufacturing Acceleration Sensor”

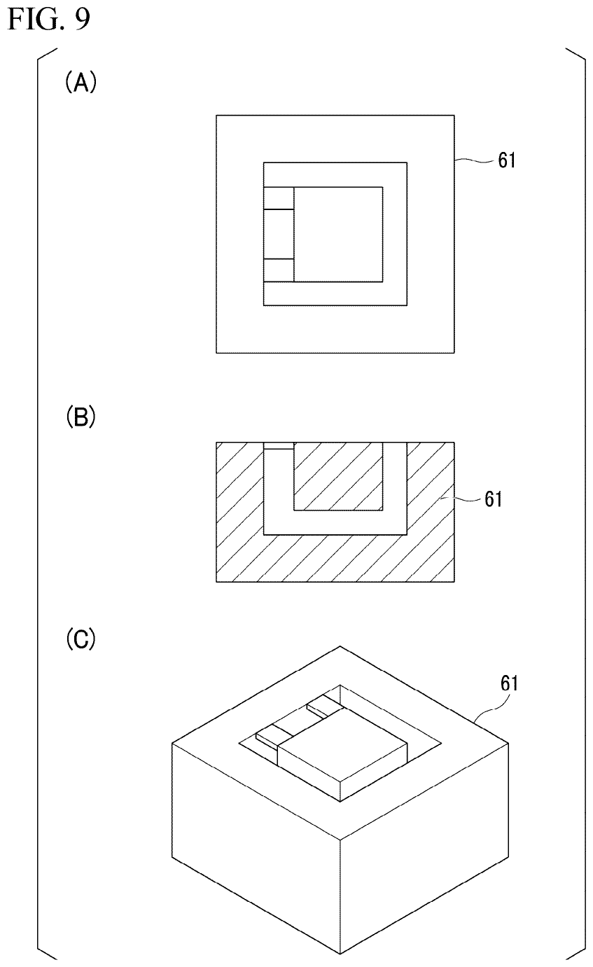

As shown in FIGS. 9(A), 9(B), and 9(C), a structure 61 having a cantilever structure was manufactured in a cube having a length of 20 mm, a width of 20 mm, and a height of 12 mm, in which the cantilever structure had a portion that was cut out 3 mm to 8 mm from the bottom and 4 mm to 6.5 mm from both side surfaces thereof as shown in the sectional view of FIG. 9(B), and one side which has a length of 2.5 mm, a width of 2 mm, and a thickness of 0.6 mm, and which is connected to the cube. PDMS (SILPOT184, manufactured by Dow Toray Co., Ltd.) was poured into a mold having a filling portion of a material having a shape corresponding to the structure 61, and dried and cured at 100° C. for 1 hour, thereby forming a structure 61 as shown in FIGS. 9(A), 9(B), and 9(C). As shown in FIG. 9(C), an inner island and an outer periphery made of PDMS was supported by a thin middle portion, and the middle portion was structured like a floating beam. When the beam structure is bent due to an external stress, an acceleration thereof can be sensed.

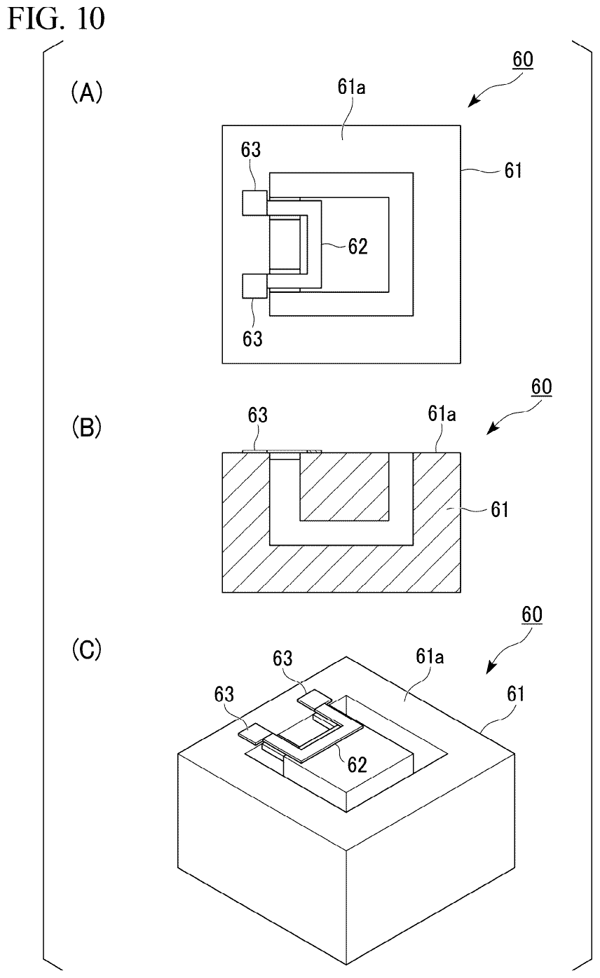

In the manufactured structure 61, a U-shaped conductive film having a length of 16 mm, a width of 1 mm, and a thickness of 0.3 mm was formed using the conductive paste composition as shown in FIGS. 10(A), 10(B), and 10(C), and then the conductive film was dried and cured at 100° C. for 1 hour, thereby forming a U-shaped conductive film 62 in plan view as shown in FIGS. 10(A) and 10(C).

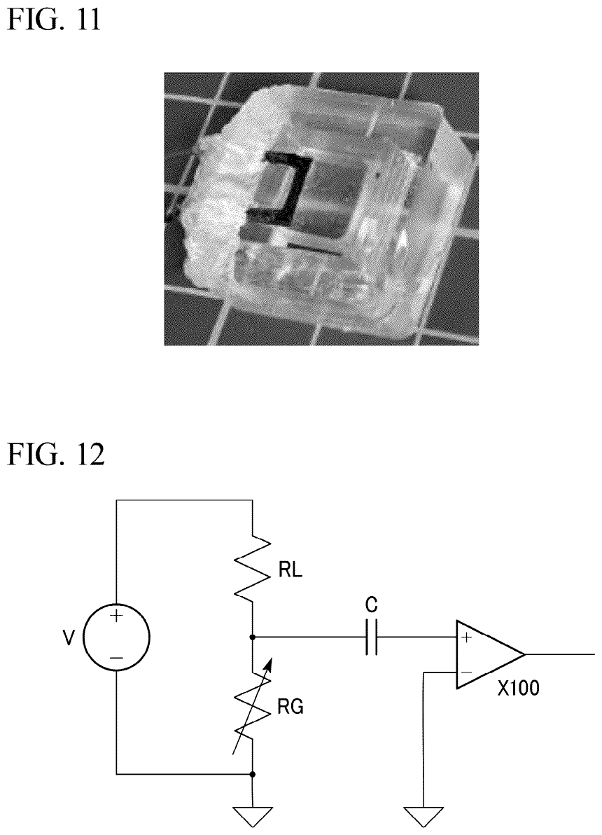

In addition, silver paste (DOTITE XA-9469, manufactured by FUJIKURA KASEI CO., LTD.) was applied so as to be in contact with both end portions of the U-shaped conductive film 62, to form an electrode 63 having a length of 2 mm, a width of 2 mm, and a thickness of 0.2 mm, and the electrode 63 was dried and cured at 150° C. for 1 hour to obtain an acceleration sensor 60 as shown in FIGS. 10(A), 10(B), 10(C), and 11.

FIG. 12 is a circuit diagram showing a control circuit for operating the acceleration sensor 60. In FIG. 12, RL represents a load resistor, RG represents a gauge resistor, C represents a capacitor, and X100 represents a voltage amplifier.

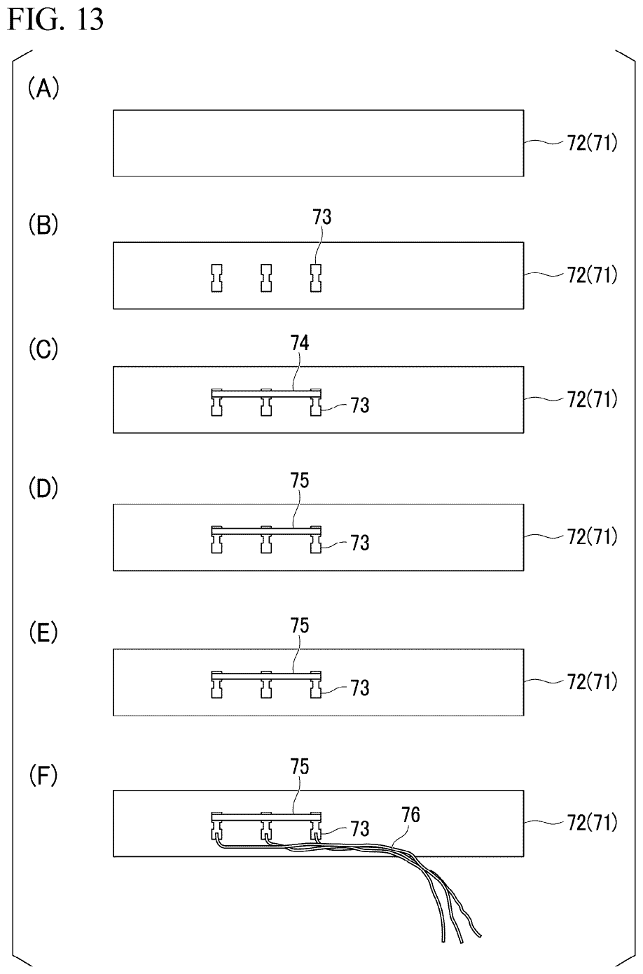

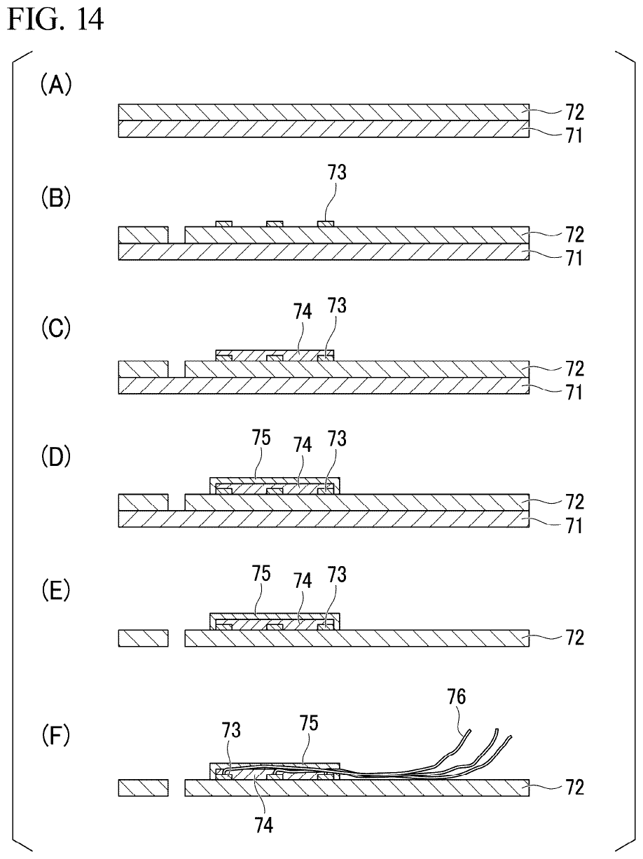

“Method for Manufacturing Pulse Wave Sensor” As shown in FIGS. 13(A) and 14(A), a PET film 71 was used as a base paper, and PDMS (SILPOT184, manufactured by Dow Toray Co., Ltd.) was used to perform stencil printing on an upper layer of the PET film 71 so as to have a size 300 mm in length, 15 mm in width, and 0.5 mm in thickness, thereby forming a PDMS base material 72.

As shown in FIGS. 13(B) and 14(B), a wire, which has a length of 4 mm, a width of 1 mm, and a thickness of 0.2 mm, was formed on the produced PDMS base material 72, and stencil printing was performed using silver paste (DOTITE XA-9469, manufactured by FUJIKURA KASEI CO., LTD) so as to have an interval of 18 mm, and then the wire was dried and cured at 100° C. for 1 hour, thereby forming an electrode 73.

As shown in FIGS. 13(C) and 14(C), the conductive paste composition was used to form a conductive film, which has a length of 108 mm, a width of 1 mm, and a thickness of 0.2 mm, on an upper layer of the produced electrode 73 by stencil printing, and then the conductive film was dried and cured at 100° C. for 1 hour, thereby forming a conductive film 74.

As shown in FIGS. 13(D) and 14(D), an insulating layer, which has a length of 108 mm, a width of 1 mm, and a thickness of 0.2 mm, was formed by the stencil printing using PDMS at an upper layer on which the conductive film 74 is formed, and then the insulating layer was dried and cured at 100° C. for 1 hour, thereby forming an insulating layer 75.

As shown in FIGS. 13(E) and 14(E), after the insulating layer 75 was formed, the PET film 71 of the base paper was peeled off, and the crosslinking treatment was performed at 180° C. for 2 hours.

As shown in FIGS. 13(F) and 14(F), silver paste (ECCOBOND 56C, manufactured by Henkel) was used to attach a lead wire 76 to the crosslinked electrode, and then dried and cured at 150° C. for 15 minutes, thereby obtaining a pulse wave sensor.

“Configuration Example of Pulse Wave Sensor”

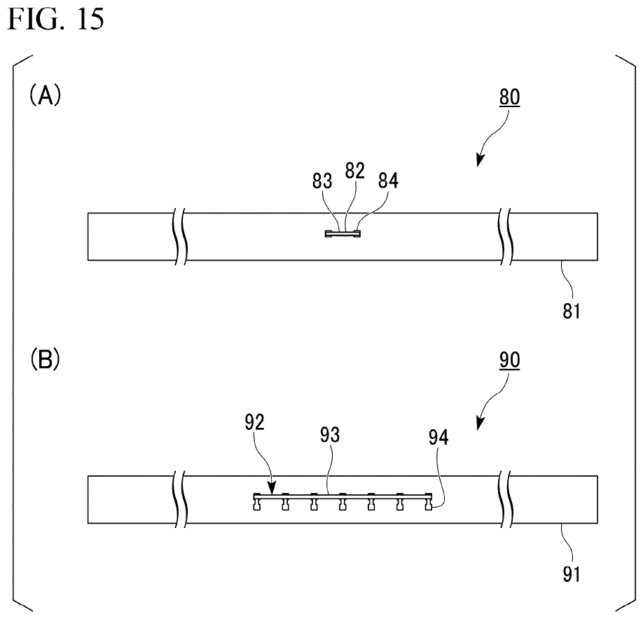

FIG. 15 is a plan view showing a configuration example of a pulse wave sensor.

A pulse wave sensor 80 shown in FIG. 15(A) includes a base material 81, one sensing unit 82 formed of a conductive film formed on the base material 81, an insulating layer 83 formed on an upper layer of the sensing unit 82, and an electrode 84.

A pulse wave sensor 90 shown in FIG. 15(B) includes a base material 91, seven sensing units 92 formed of a conductive film formed on the base material 91, an insulating layer 93 formed on an upper layer of the sensing unit 92, and an electrode 94.

“Configuration Example of Pulse Wave Sensor”

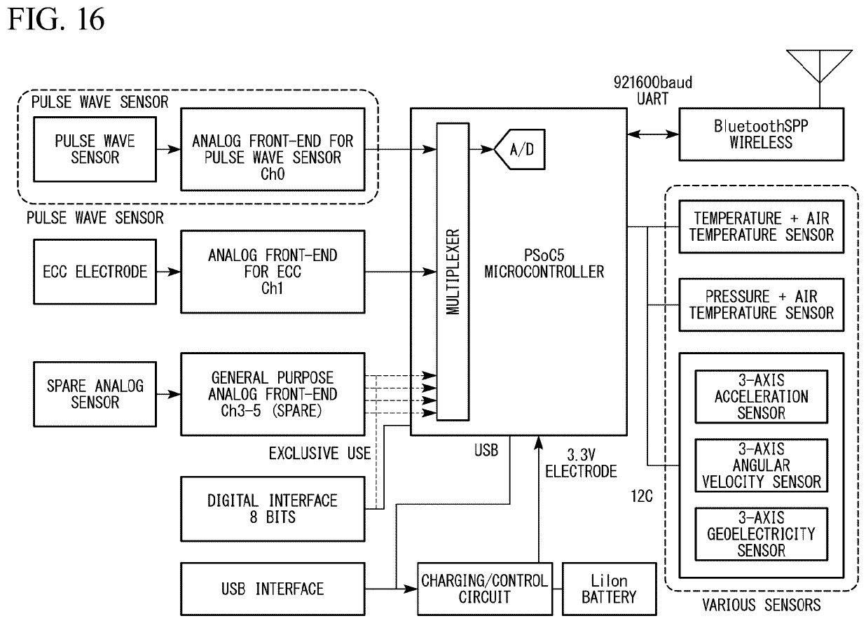

FIG. 16 is a circuit diagram showing a system block diagram for operating the pulse wave sensor. The pulse wave sensor described above is used as the pulse wave sensor shown in FIG. 16. As shown in FIG. 16, the pulse wave sensor and various sensors are combined, so that multifaceted sensing can be performed at a time.

“Evaluation”

Evaluation was performed on the following (1) to (5) by using the obtained conductive paste composition.

(1) Surface Resistance of Conductive Film

The obtained conductive paste composition was poured into a mold, and dried and cured at 180° C. for 2 hours to form a conductive film.

The surface resistance (kΩ) of the obtained conductive film was measured by a method in accordance with JIS K 6271 using a measurement power supply 6241 A manufactured by ADC Corporation, and conductivity of the produced conductive film was evaluated. Results are shown in Tables 1 and 2.

(2) Hardness of Conductive Film

A conductive film was formed in the same manner as in a case of the surface resistance of the conductive film.

The hardness of the obtained conductive film was measured according to a durometer type A (shore A) specified in JIS K6253.

Results are shown in Tables 1 and 2.

(3) Content of Carbon Material in Conductive Film

A conductive film was formed in the same manner as in a case of the surface resistance of the conductive film.

The content (% by mass) of the carbon material in the obtained conductive film was measured using a thermogravimetric analysis device that is set in accordance with JIS K 6226.

Results are shown in Tables 1 and 2.

(4) Sensing Stability Against Strain

The conductive paste composition was applied on a flat silicone rubber having a thickness of 0.2 mm, a length of 300 mm, and a width of 15 mm by using a stencil mask, and the applied conductive paste composition was dried to form a linear conductive film in plan view. The linear conductive film has a thickness of 0.3 mm, a length of 18 mm, and a width of 1 mm.

In addition, silver paste (“DOTITE XA-9469” manufactured by Fujikura Kasei Co., Ltd.) was applied so as to be in contact with both end portions of the linear conductive film to form an electrode and obtained a test piece.

The obtained test piece was measured by setting a distance between chucks to 200 mm and setting a tensile speed so that a predetermined amount of strain was reached in 5 seconds.

A temperature of the atmosphere during the test was 23° C. and the humidity was 50%.

The tensile conditions were set as follows. Condition (1) was defined as small deformation, and Condition (2) was defined as large deformation.

Condition (1)

The test piece was pulled so that the tensile strain was 0.5% (length in the pulled state −length before pulling=1 mm), and after the tensile strain reached 0.5%, the tensile strain relaxed and returned to 0%. One cycle of tension (0.5% strain) and relaxation was repeated 100 times, and the surface resistance of the conductive film at that time was measured. The surface resistance (kΩ) of the conductive film was measured by a method in accordance with JIS K 6271 using a measurement power supply 6241A manufactured by ADC Corporation, and conductivity of the produced conductive film was evaluated.

The sensing stability against strain was evaluated as follows: (A) Stability under 0% strain (change in surface resistance of the conductive film in a state where the strain is 0% before and after the repeated deformation); (B) Stability under 0.5% strain (change in surface resistance of the conductive film when the strain is 0.5% immediately after the deformation and after the repeated deformation); and (C) Goodness of sensing sensitivity (reproducibility, presence/absence of noise) when strain is applied.

(A) Stability under 0% strain (change in surface resistance of the conductive film in a state where the strain is 0% before and after the repeated deformation)

A surface resistance of the conductive film before pulling (0% strain) was defined as “R0”, and a surface resistance of the conductive film after repeated deformation (0% strain) was defined as “R”. A resistance change rate, which is defined by ((R−R0)/R0)(%) of the surface resistance (R) of the conductive film after repeated deformation (in a state where the strain returns to 0% after relaxation), with respect to the surface resistance (R0) of the conductive film before pulling (strain 0%), was calculated. The resistance change rate was calculated based on the following Equation (1).

Resistance change rate=((R−R0)/R0)×100 (1)
R: Surface resistance of conductive film after repeated deformation (0% strain)
R0: (Surface resistance of conductive film before pulling (0% strain))
(B) Stability under 0.5% strain (change in surface resistance when the strain is 0.5% immediately after the deformation and after the repeated deformation)

For (B), a change rate was determined using Equation (1) in the same manner as for (A). A surface resistance of the conductive film at 0.5% strain immediately after deformation (surface resistance measured in a state where the tensile strain was maintained at 0.5% by the first pulling) was set to “R0”, a surface resistance of the conductive film after repeated deformation (0.5% strain) (surface resistance measured in a state where the tensile strain was maintained at 0.5% after repeated pulling and relaxing for 100 cycles) was set to “R”, and “R0” and “R” were calculated by applying to Equation (1).

(C) Goodness of sensing sensitivity (reproducibility, presence/absence of noise) when strain is evaluated. Similar to (A) and (B), reproducibility was evaluated using the change rate through Equation (1). Variation in resistance change rate at 0.5% tensile strain for each cycle was evaluated by standard deviation, in which when the standard deviation was 0.2 or less, it was marked as A, when the standard deviation was 0.4 or less, it was marked as B, and when the standard deviation exceeded 0.4, it was marked as C. In addition, a frequency at which noise was detected in 100 cycles was evaluated, in which the frequency is 3 or less times, it was marked as A, when the frequency is 5 or less times, it was marked as B, and when the frequency exceeded 5 times, it was marked as C. The indices of the reproducibility and the noise were combined, so that goodness of the sensing sensitivity was comprehensively evaluated. When any item of the reproducibility and the noise was C, the comprehensive evaluation was marked as C, and when both items of the reproducibility and the noise were A, the comprehensive evaluation was marked as A, and other comprehensive evaluations were marked as B.

Results are shown in Tables 1 and 2.

Condition (2)

The test piece was pulled so that the tensile strain was 5.0% (10 mm), and after the tensile strain reached 5.0%, the tensile strain relaxed and returned to 0%. One cycle of tension (5.0% strain) and relaxation was repeated 100 times, and the surface resistance of the conductive film at that time was measured. The surface resistance (kΩ) of the conductive film was measured by a method in accordance with JIS K 6271 using a measurement power supply 6241A manufactured by ADC Corporation, and conductivity of the produced conductive film was evaluated. Sensing stability against strain was also evaluated by three items (A), (B), and (C) as in Condition (1). Regarding (A), the reproducibility for (A) stability under 0% strain (change in surface resistance of the conductive film in a state where the strain is 0% before and after the repeated deformation) and (C) goodness of sensing sensitivity (reproducibility, presence/absence of noise) when strain is applied was evaluated using a change rate through Equation (1), as in (A) and (B). Variation in resistance change rate at 5.0% tensile strain for each cycle was evaluated by standard deviation, in which when the standard deviation was 0.3 or less, it was marked as A, when the standard deviation was 0.6 or less, it was marked as B, and when the standard deviation exceeded 0.6, it was marked as C. In addition, a frequency at which noise was detected in 100 cycles was evaluated, in which the frequency is 3 or less times, it was marked as A, when the frequency is 5 or less times, it was marked as B, and when the frequency exceeded 5 times, it was marked as C. The indices of the reproducibility and the noise were combined, so that goodness of the sensing sensitivity was comprehensively evaluated.

(B) Stability under 5.0% strain (change in surface resistance when the strain is 5.0% immediately after the deformation and after the repeated deformation)

A surface resistance of the conductive film at 5.0% strain immediately after deformation was defined as “R0”, a surface resistance of the conductive film after repeated deformation (5.0% strain) was defined as “R”, and “R0” and “R” were calculated by applying Equation (1).

(5) Sensing Stability Against Temperature

The obtained conductive paste composition was applied on a flat silicon rubber having a thickness of 0.2 mm, a length of 50 mm, and a width of 50 mm by using a stencil mask, and the applied conductive paste composition was dried to form a U-shaped conductive film in plan view, as shown in FIG. 4. A thickness of each side of the U-shaped conductive film was 0.8 mm, a length of each side of the U-shaped conductive film was 6 mm, and a width of each side of the U-shaped conductive film was 1 mm. In addition, silver paste (“DOTITE XA-9469” manufactured by Fujikura Kasei Co., Ltd.) was applied so as to be in contact with both end portions of the U-shaped conductive film to form an electrode and obtained a test piece.

The test piece was placed on an aluminum plate in a constant humidity and temperature bath set at 60% humidity, and a voltage of 1 V was applied between two electrodes of the conductive film.

In a state where the voltage was applied to the conductive film, a temperature of the constant temperature bath was raised from 10° C. to 50° C. at a rate of about 2.0° C./min. After holding for 60 minutes at 10° C. as a starting point, the temperature was raised to 23° C. and 50° C. and held for 20 minutes. The surface resistance of the conductive film was measured at a place where the temperature was stabilized at each raised temperature (23° C. and 50° C.). The surface resistance (kΩ) of the conductive film was measured by a method in accordance with JIS K 6271 using a measurement power supply 6241A manufactured by ADC Corporation, and conductivity of the produced conductive film was evaluated. A surface resistance of the test piece at 10° C. was defined as “R0”, and a surface resistance of the conductive film at each temperature was defined as “R”. A resistance change rate ((R−R0)/R0)(%), which is defined by the surface resistance (R) of the conductive film at each temperature, with respect to the surface resistance (R0) of the conductive film at 10° C., was calculated.

The resistance change rate was calculated based on the following Equation (2).

Resistance change rate=((R−R0)/R0)×100 (2)
R: Surface resistance of conductive film at each temperature
R0: Surface resistance of conductive film at 10° C.

Results are shown in Tables 1 and 2.

(6) Elasticity of Conductive Film

The conductive film obtained in the same producing method as in Condition (1) was used to form a U-shaped conductive film in plan view, as shown in FIG. 4. Elasticity was evaluated by pulling the conductive film from both end portions at a tensile speed of 500 mm/min so as to be line symmetrical. A conductive film that was stretched 200% or greater was marked as A, a conductive film that was stretched 100% or greater was marked as B, and a conductive film that was broken at less than 100% was marked as C. Results are shown in Tables 1 and 2.

(7) Tear Strength

A crescent-shaped test piece was produced in accordance with JIS K6252-1 using a conductive film having a thickness of 1 mm, which was obtained using the same preparation method as the surface resistance of the conductive film, and a tear strength of the obtained crescent-shaped test piece was measured at room temperature of 25° C. The unit of the tear strength is kN/m. Results are shown in Tables 1 and 2.

(8) Sensing Sensitivity of Each Sensor

An operation of each manufactured sensor was confirmed, and the sensing sensitivity and sensing stability were comprehensively evaluated from the reproducibility and the presence/absence of noise of the obtained sensing sensitivity. A sensor whose operation was confirmed that the sensor was particularly excellent in sensing sensitivity and sensing stability was marked as A, a sensor whose operation was excellent in sensing sensitivity and sensing stability was marked as B, and a sensor whose operation was poor (not performed) in sensing sensitivity and sensing stability was marked as C. Results are shown in Tables 1 and 2.

### Examples 2 to 13 and Comparative Examples 1 to 4

Conductive paste compositions of Examples 2 to 13 and Comparative Examples 1 to 4 were prepared in the same manner as Example 1, except that each component shown in Table 1 was used and a content of each component was used as shown in Table 1.

Evaluation was performed on (1) to (8) described above using the obtained conductive paste composition. Results are shown in Tables 1 and 2.

### Example 2

An equivalent amount of A-2 (DBP oil absorption amount: 323 mL/100 g, specific surface area: 780 m²/g) was blended in place of A-1 blended in Example 1.

### Example 3

An equivalent amount of A-3 (DBP oil absorption amount: 454 mL/100 g, specific surface area: 1,260 m²/g) was blended in place of A-1 blended in Example 1.

### Example 4

An equivalent amount of B-2 was blended in place of B-1 blended in Example 3.

### Example 5

An equivalent amount of B-3 was blended in place of B-1 blended in Example 3.

### Example 6

An equivalent amount of B-4 was blended in place of B-1 blended in Example 3. (*B-4 was additionally blended with silica in B-3)

### Example 7

An equivalent amount of A-4 (DBP oil absorption amount: 330 mL/100 g, specific surface area: 1,475 m²/g) was blended in place of A-1 blended in Example 1.

### Example 8

An equivalent amount of A-5 (DBP oil absorption amount: 380 mL/100 g, specific surface area: 815 m²/g) was blended in place of A-1 blended in Example 1.

### Example 9, Example 10, and Example 11

The blending amount of A-3 blended in Example 3 was changed.

### Example 12 and Example 13

An equivalent amount of each of B-5 and B-6 was blended in place of B-1 blended in Example 3.

### Comparative Example 1

A-6 (DBP oil absorption amount: 140 mL/100 g, specific surface area: 39 m²/g) was blended in place of A-1 blended in Example 1.

### Comparative Example 2

A-7, which is a carbon nanotube, was blended in place of A-I blended in Example 1.

### Comparative Example 3

The amount of A-3 blended in Example 3 was reduced.

### Comparative Example 4

The amount of A-3 blended in Example 3 was increased.

Table 4 shows a product name, a DBP oil absorption amount, and a specific surface area of the carbon materials (conductive carbon) used in Examples and Comparative Examples.

TABLE 4

| | | | DPB oil | Specific |
|---|---|---|---|---|
| | | | absorption | surface |
| | | | amount | area |
| | Product name | Manufacturer | (mL/100 g) | (m²/g) |
| Conductive | Lionite EC200L | LION | 255 | 380 |
| carbon | Ketjenblack | SPECIALTY | 323 | 780 |
| | EC300J | CHEMICALS | | |
| | Ketjenblack | CO., Ltd. | 454 | 1260 |
| | EC600JD | | | |
| | BlackPearls 2000 | Cabot Japan | 330 | 1475 |
| | | Corporation | | |
| | chezacarb AC-60 | Unipetrol | 380 | 815 |
| | Denka black | Denka | 140 | 39 |
| | HS-100 | Company | | |
| | | Limited | | |

From the results of Table 1 and Table 2, it was found that the conductive film formed of the conductive paste composition of Examples 1 to 13 can realize an electrically resistant sensor having excellent sensing stability against temperature and strain compared to the conductive film formed of the conductive paste composition of Comparative Examples 1 to 4. For example, the conductive paste composition blended with the porous carbon black shown in Example 3 has excellent sensing stability against temperature and strain, compared to the conductive paste composition blended with the non-porous carbon black shown in Comparative Example 1 or the conductive paste composition blended with the carbon nanotubes shown in Comparative Example 2. Even with porous carbon black, when the blending amount is out of a predetermined blending amount range, for example, in Comparative Example 3 where the blending amount is less than the range, conductivity cannot be exhibited and sensing cannot be performed, and in Comparative Example 4 where the blending amount exceeds the range, sensing stability cannot be secured.

“Usage Example of Surface Pressure Distribution Sensor”

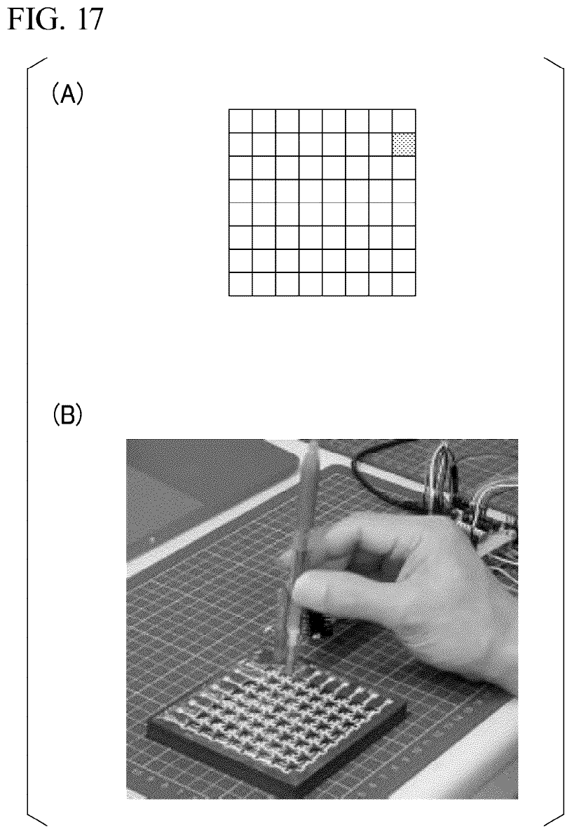

FIGS. 17 to 19 are views showing usage examples of the surface pressure distribution sensor. FIGS. 17(A) to 19(A) are views showing a display surface of a display device, which shows a sensing result of the surface pressure distribution sensor shown in FIGS. 17(B) to 19(B). One square on the display surface shown in FIGS. 17(A) to 19(A) corresponds to a lattice-shaped resistors shown in FIGS. 17(B) to 19(B).

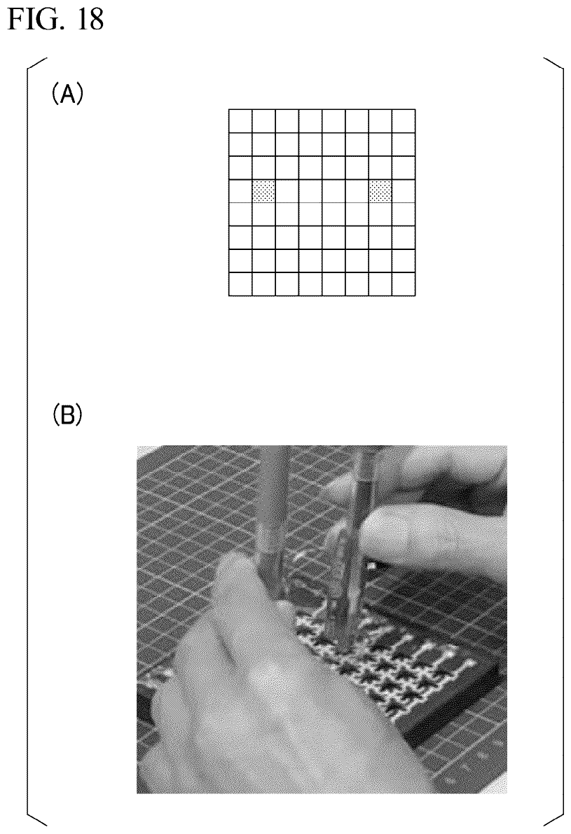

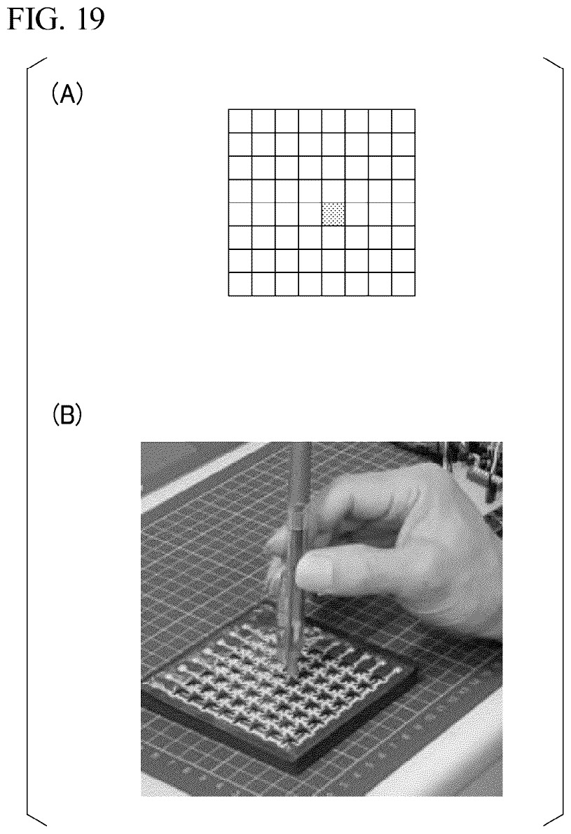

FIG. 17(A) shows that a color of the square on the display surface, which corresponds to a portion (lattice-shaped resistor) pressed by a pen in FIG. 17(B), is changed (for example, shining). Similarly, FIG. 18(A) shows that a color of the square on the display surface, which corresponds to a portion (lattice-shaped resistor) pressed by a pen in FIG. 18(B), is changed. In addition, FIG. 19(A) shows that a color of the square on the display surface, which corresponds to a portion (lattice-shaped resistor) pressed by a pen in FIG. 19(B), is changed.

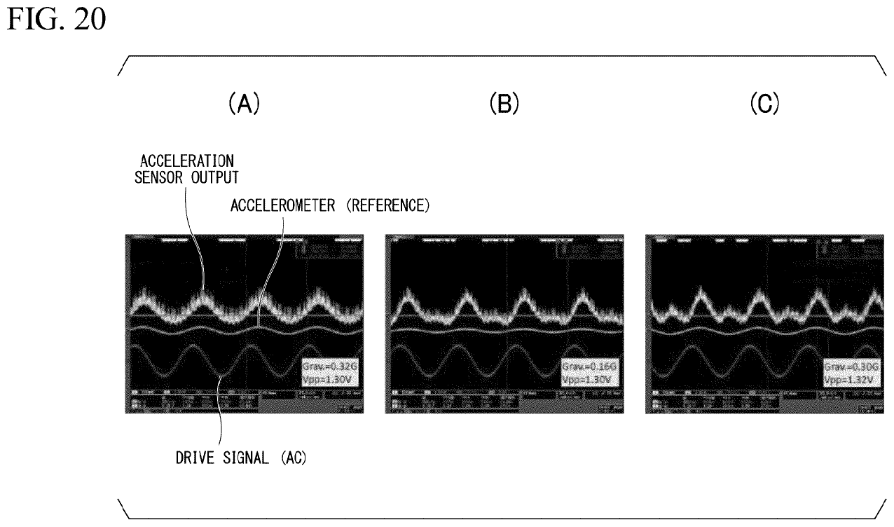

“Usage Example of Acceleration Sensor” FIG. 20 is a diagram showing a usage example of the acceleration sensor. FIG. 20(A) shows a case of the acceleration sensor in which the conductive film constituting the sensing unit contains porous carbon black. FIG. 20(B) shows a case of the acceleration sensor in which the conductive film constituting the sensing unit contains carbon nanotubes. FIG. 20(C) shows a case of the acceleration sensor in which the conductive film constituting the sensing unit contains acetylene black, which is non-porous carbon black. As shown in FIGS. 20(A) to 20(C), it can be seen that in any acceleration sensor, the acceleration sensor output corresponds to a drive signal (AC) input from the outside. In addition, as shown in FIG. 20(A), the acceleration sensor in which the conductive film constituting the sensing unit contains porous carbon black has the cleanest accelerometer output waveform and is excellent in sensing. On the other hand, with carbon nanotubes (Comparative Example 2), the shift to the drive signal cannot be confirmed, but a peak corresponding to a downwardly protruding portion cannot be detected properly, and waveform reproducibility is not good as that of the porous carbon black. In addition, with acetylene black (Comparative Example 1), which is non-porous carbon black, the phase shift from the drive signal was confirmed, and it was thus found that the reproducibility of the waveform was not good.

“Usage Example of Pulse Wave Sensor”

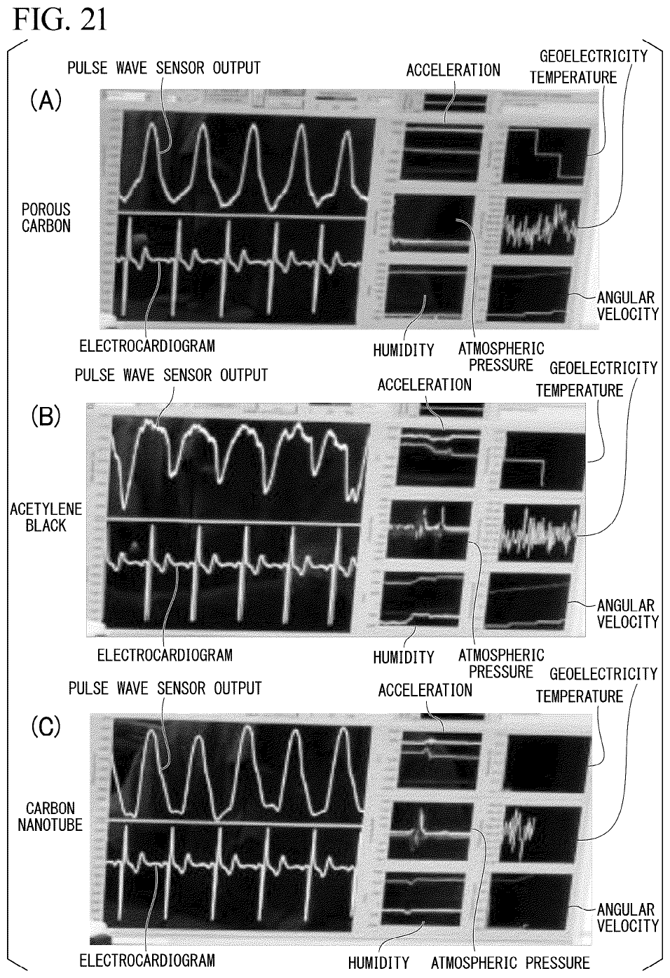

FIG. 21 is a diagram showing a usage example of a pulse wave sensor. FIG. 21(A) shows a diagram of a pulse wave which is measured using a pulse wave sensor in which the conductive film constituting the sensing unit contains porous carbon black. FIG. 21(B) shows a diagram of a pulse wave which is measured using a pulse wave sensor in which the conductive film constituting the sensing unit contains acetylene black, which is a non-porous carbon black. FIG. 21(C) shows a diagram of a pulse wave which is measured using a pulse wave sensor in which the conductive film constituting the sensing unit contains carbon nanotubes. From FIGS. 21(A) and 21(C), it can be seen that the pulse wave sensor containing porous carbon black and the pulse wave sensor containing carbon nanotubes correlate sensing peaks with an actual electrocardiogram. A pulse wave sensor (A) containing the porous carbon black has excellent waveform reproducibility, baseline stability, and sensing sensitivity as compared to the pulse wave sensor (C) containing carbon nanotubes. In the pulse wave sensor (B) containing acetylene black, which is non-porous carbon black, has poor reproducibility because the waveform is not constant and the vertical width is not uniform, and the sensing sensitivity is inferior because the influence of noise in confirmed.

### REFERENCE SIGNS LIST

1, 10, 20, 30: Electrically resistant sensor
2: First electrode wire
2A to 2G: Electrode wire
3: Second electrode wire
3A to 3G: Electrode wire
4: Resistor including conductive film
5: Insulating base material
6: Insulator
7, 8, 23, 33: Electrode
21, 31: Insulating base material
22, 32: Strain measurement unit

1. A conductive paste composition comprising:
carbon black having a porous structure and having a DBP oil absorption amount of greater than 240 mL/100 g and a specific surface area of greater than 350 m²/g; and
a liquid silicone rubber base composition,
wherein in a case where the conductive paste composition is dried and cured at 180° C. for two hours to form a conductive film, a content of the carbon black in the conductive film is 4% by mass or greater and 24% by mass or less, and a surface resistance of the conductive film is 1 kΩ or greater and 9 kΩ or less.

2. The conductive paste composition according to claim 1,
wherein when deformation is repeatedly performed at a predetermined strain value within a range of a strain of 0.5% to 5.0%, the conductive film obtained from the conductive paste composition simultaneously satisfies the following (A) and (B) as indices of sensing stability against the strain:
(A) stability under 0% strain (change in surface resistance of the conductive film in a state where the strain is 0% before and after the repeated deformation) is less than 2%, and
(B) stability under (0.5% to 5.0%) strain (change in surface resistance of the conductive film in a state where the strain is 0.5% to 5.0% immediately after the deformation and after the repeated deformation) is less than 2%.

3. The conductive paste composition according to claim 1,
wherein when deformation is repeatedly performed at a predetermined strain value within a range of a strain of 0.5% to 5.0%, the conductive film obtained from the conductive paste composition satisfies the following (C) as an index of sensing stability against the strain:
(C) sensing sensitivity when the strain is applied is good in terms of reproducibility and presence/absence of noise.

4. The conductive paste composition according to claim 1,
wherein the conductive film obtained from the conductive paste composition has a resistance change rate of 5% or less, which is defined as a ratio of a number of increase in surface resistance after temperature change (a humidity of 60%, a temperature of higher than 10° C. and 50° C. or lower) to a number of increase in surface resistance before the temperature change (a humidity of 60%, a temperature of 10° C.).

5. The conductive paste composition according to claim 1,
wherein a tear strength after the curing is 15 kN/m or greater.

6. A conductive film, which is obtained from the conductive paste composition according to claim 1.

7. An electrically resistant sensor comprising:
a sensing unit including the conductive film according to claim 6,
wherein an electrical resistance is changed due to a magnitude of an external stress.

8. The electrically resistant sensor according to claim 7, further comprising:
a first electrode wire extending in one direction;
a second electrode wire provided to extend in a direction orthogonal to the one direction so as to overlap the first electrode wire; and
a resistor including a conductive film configured to connect the first electrode wire and the second electrode wire at a portion where the first electrode wire and the second electrode wire do not overlap each other
wherein the resistor including the conductive film is the sensing unit.

9. The electrically resistant sensor according to claim 8,
wherein the conductive film has an L shape in plan view.

10. The electrically resistant sensor according to claim 8,
wherein each of the first electrode wire and the second electrode wire is a plurality of electrode wires provided in parallel, forms a sheet-like sensor, and has one or two or more layers of the sheet-like sensor.

11. The electrically resistant sensor according to claim 7, further comprising:
an insulating base material configured to be elastically deformable; and
a strain measurement unit formed on the insulating base material and having a U shape in plan view,
wherein the strain measurement unit is the sensing unit.

12. The electrically resistant sensor according to claim 7, further comprising:
an insulating base material configured to be elastically deformable; and
a strain measurement unit formed on the insulating base material and having a linear shape in plan view,
wherein the strain measurement unit is one or more sensing units arranged side by side in the same direction.
